(19) United States
(12) Patent Application Publication
(10) Pub. No.: US 2006/0288896 A1
(43) Pub. Date: Dec. 28, 2006

(54) Image forming apparatus and image forming method

(75) Inventors: Tamio Fukui, Kyoto (JP); Masaaki Aoike, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG CO., LTD

(21) Appl. No.: 11/473,144

(22) Filed: Jun. 23, 2006

(30) Foreign Application Priority Data
Jun. 24, 2005 (JP) P2005-184806
Jun. 24, 2005 (JP) P2005-184807

(51) Int. Cl. B41M 1/42

(52) U.S. Cl. 101/489

(57) ABSTRACT

In an image forming apparatus (1), on lower surface of a semiconductor support belt (201) for supporting a glass substrate (9), a transfer potential is applied to a position thereon closest to a transfer position and an auxiliary potential which is nearer to a surface potential of a photosensitive material (312) than the transfer potential is applied to a position thereon away from this position at a predetermined distance in a direction parallel to a traveling direction of the glass substrate (9). With this operation, a potential having a distribution where the difference between the potential and the surface potential of the photosensitive material (312) gradually decreases as the distance from the transfer position becomes larger is given to the glass substrate (9) through the support belt (201). This prevents discharge in a gap between the photosensitive material (312) and the glass substrate (9).

### BACKGROUND OF THE INVENTION

1. Field of the Invention

The present invention relates to a technique to form a toner image or an electrostatic latent image on a substrate.

2. Description of the Background Art

An electrophotographic printer which forms a toner image on printing paper by irradiating a photosensitive drum having an electrically-charged photosensitive material with light to form an electrostatic latent image, applying toner to the electrostatic latent image to make the image apparent as a toner image and then transferring the image to the printing paper has been conventionally used. For transferring a toner image to printing paper, such a printer uses a transferring method using electric field, where an electric field is formed by bringing the printing paper into contact with an outer peripheral surface of a photosensitive drum while applying a potential to one side of the printing paper opposite to the photosensitive drum at a predetermined transfer position and then toner which is a mass of charged particles (or charged particles in liquid) is moved from the photosensitive material to the printing paper.

It is known, however, that depending on the potential applied to the printing paper in transferring the toner image, the electric field locally becomes strong to cause discharge in a gap between the photosensitive drum and the printing paper in the vicinity of the transfer position and this disturbs the toner image. Then, a technique to suppress such discharge in the gap between the photosensitive drum and the printing paper immediately after being separated from the photosensitive drum is disclosed in, for example, “Principles and Application of Electrophotography Technique” edited by Society of Electrophotography of Japan, CORONA PUBLISHING CO., LTD, 1988, pp. 186-189 (Document 1) and “Latest Technique for Electrophotography Process and Optimal Design and Application & Development of Apparatus” by Hiroshi TAKAHARA, Keiei Kaihatsu Center Shuppanbu (Management and Development Center, Publishing Section), Jun. 30, 1989, p. 6652 (Document 2), where an AC corona discharger is provided on a side of printing paper opposite to a photosensitive drum in the downstream of a transfer position and electric charges applied to the printing paper from other DC corona discharger in transfer are thereby quickly removed in the downstream. Also known is a technique to suppress discharge, where printing paper is bent with small curvature in the vicinity of a transfer position and moved along its surface, to sharply increase the width of a gap between the photosensitive drum and the printing paper as the distance from the transfer position becomes larger along a tangential direction of the photosensitive drum at the transfer position.

Other than electrophotography known is a technique to form an electrostatic latent image on a drum having a dielectric layer, using a multistylus which is a set of pin electrodes.

The printing technique which utilizes the transferring method using electric field has begun to be used in various fields from printing by general-type image output devices (image printers) to patterning for industrial production such as printed circuit boards, color filters for liquid crystal panel or textile printing, because of its simplicity which allows a free change of pattern only by changing electronic data without using any plate and its high speed and high-resolution output.

Japanese Patent Application Laid Open Gazette No. 58-57783 discloses a method of forming patterns for printed circuit board, which uses electrophotography to eliminate the necessity of processes of applying and removing a photoresist, mask coating or the like. Japanese Patent Application Laid Open Gazette No. 5-283838 discloses a method of forming patterns for printed circuit board, where a toner image is formed by electrophotographic printing, to mask a photoresist part corresponding to a conductive pattern, and this prevents defects such as positional errors of the conductive pattern or the like. Japanese Patent Application Laid Open Gazette No. 7-254768 discloses a technique of preventing disturbance of patterns caused in a transferring process of a method of manufacturing a circuit board, where charged particles are induced to the board (substrate) in accordance with an image signal to form an image of charged particles corresponding to a pattern and the electrostatic latent image is thereby directly supplied with developer, regardless of thickness of the board, for development. Japanese Translation of a PCT, No. 2002-527783 discloses a technique of performing electrostatic printing on a glass substrate with a functional (high-performance) material which is liquid toner in manufacturing color filters for liquid crystal panel. Japanese Patent Application Laid Open Gazette No. 5-27474 discloses a method of electrophotographic textile printing and toner for the textile printing.

A printed circuit board and a color filter are formed of rigid flat materials. As a method of transfer onto such a rigid flat panel, a roller transfer which is transfer using pressure and electric field, a transfer using heat and pressure through an intermediate transfer belt and the like have been suggested. For the printed circuit board and the color filter, however, a printing with much higher dimensional accuracy than that in a case of general-type images is required, but it is difficult, in the roller transfer or the transfer through the intermediate transfer belt, to achieve the required accuracy, because of conveyance error due to transfer pressure and cumulative error due to use of the transfer belt.

On the other hand, when a photosensitive drum and an object to which an image is transferred are made closer to each other or separated with applying a potential, an electric field is concentrated in a gap between them and there is a probability that discharge should occur in a gap of certain size, depending on the magnitude of the electric field. Since a potential required for transfer onto a material having a large thickness and low dielectric constant, such as a printed circuit board or glass of color filter, is so high, a large electric field is formed in a wide range of the gap ahead and behind a transfer position between the photosensitive drum and the object to which an image is transferred and discharge is thereby caused to break the image.

In the techniques of Document 1 and Document 2, since the AC corona discharger uses a high-voltage alternating current, there is a problem of easily causing noise in a printer. Further, since a glass substrate can not be bent along its surface, the above method in which an object is moved while being bent with small curvature in the vicinity of the transfer position can not be used.

Though there is a possible technique where a loop member like a flat belt with high capacitance is provided as an intermediate transfer member and a toner image on a photosensitive material which is another loop member provided along an outer periphery of a photosensitive drum is once transferred to the intermediate transfer member with a relatively low transfer bias and then the toner image is transferred from the intermediate transfer member to the glass substrate, even in such a case, when the toner image is transferred to the glass substrate, a relatively large transfer potential is required, and this easily causes discharge disadvantageously.

### SUMMARY OF THE INVENTION

The present invention is intended for an image forming apparatus for forming a toner image or an electrostatic latent image on a substrate. It is an object of the present invention to transfer an image from a loop member to a substrate with high accuracy in transferring an original image from the loop member having an outer peripheral surface on which the original image is formed as a form of toner image or electrostatic latent image to the substrate.

According to the present invention, the image forming apparatus comprises an original image holding part for rotatingly moving a loop member like a cylindrical drum or a flat belt along its outer peripheral surface on which an original image which is a toner image or an electrostatic latent image to be transferred is formed, a moving mechanism for bringing one main surface of the substrate closest to the outer peripheral surface at a predetermined transfer position while moving the substrate at the same speed as a portion of the loop member goes at the transfer position in a traveling direction along the one main surface which is the same direction as the portion of the loop member, and a transfer part for transferring the original image on the outer peripheral surface to the substrate at the transfer position while applying a potential to a surface of the substrate opposite to the one main surface, the potential having a distribution where the difference between the potential and a surface potential of the loop member gradually decreases as the distance from the transfer position toward the traveling direction or one direction opposite to the traveling direction becomes larger.

In the image forming apparatus, since the potential having the distribution where the difference between the potential and the surface potential of the loop member gradually decreases as the distance from the transfer position toward one direction becomes larger is given to the substrate, it is possible to prevent (suppress) discharge from occurring in a gap between the loop member and the substrate in the vicinity of the transfer position and transfer the original image from the loop member on the substrate with high accuracy.

According to one preferred embodiment, the image forming apparatus further comprises a supporting member having a contact surface which comes into contact with the surface of the substrate opposite to the one main surface in the vicinity of the transfer position and the supporting member is formed of a semiconductor material having a constant thickness, and the transfer part comprises a first potential applying part for applying a first potential to a position on a surface of the supporting member opposite to the contact surface, which is closest to the transfer position, and a second potential applying part for applying a second potential which is nearer to the surface potential of the loop member than the first potential to the supporting member at a position away from the first potential applying part at a predetermined distance toward the one direction, to generate a potential having the distribution on the supporting member.

This makes it possible to easily apply the potential having the distribution to the substrate.

More preferably, a distribution of the potential which is applied by the transfer part to the surface of the substrate opposite to the one main surface further has a distribution where the difference between the potential and a surface potential of the loop member gradually decreases as the distance from the transfer position toward a direction opposite to the one direction becomes larger.

In this case, the image forming apparatus in accordance with a preferred embodiment further comprises a supporting member having a contact surface which comes into contact with a surface of the substrate opposite to the one main surface in the vicinity of the transfer position and the supporting member is formed of a semiconductor material having a constant thickness, and the transfer part comprises a first potential applying part for applying a first potential to a position on a surface of the supporting member opposite to the contact surface, which is closest to the transfer position, and two second potential applying parts for applying a second potential which is nearer to the surface potential of the loop member than the first potential to the supporting member at positions away from the first potential applying part at a predetermined distance toward the one direction and a direction opposite to the one direction, respectively, to generate a potential having the distribution on the supporting member.

According to another preferred embodiment of the present invention, the image forming apparatus further comprises a substrate holding part for holding the substrate on a flat holding surface formed on a member having rigidity, and in the image forming apparatus, the moving mechanism moves the substrate holding part to move the substrate and the transfer part is a potential applying mechanism for applying the potential to the holding surface.

In the image forming apparatus, since the substrate is held on the flat holding surface formed on the member having rigidity, it is possible to transfer the original image from the loop member to the substrate with high accuracy.

According to one preferred embodiment, the potential applying mechanism comprises a plurality of linear electrodes each extending in a direction orthogonal to the traveling direction, which are arranged in the traveling direction at a regular pitch in the substrate holding part, a resistance material covering the plurality of linear electrodes and having a surface which serves as the holding surface, and a potential applying electrode shift mechanism for applying a first potential to one of the plurality of linear electrodes which is located at the transfer position, applying a second potential which is nearer to a surface potential of the loop member than the first potential to one of the plurality of linear electrodes which is located away from the transfer position at a predetermined distance in the traveling direction or a direction opposite to the traveling direction, and sequentially shifting a linear electrode to which the first potential is applied and a linear electrode to which the second potential is applied in synchronization with the movement of the substrate holding part.

Preferably, adjacent two of the plurality of linear electrodes are connected to each other with a resistance element having a resistance value lower than that of the resistance material located between adjacent two linear electrodes.

In the image forming apparatus, since the linear electrodes are covered with the resistance material, it is possible to easily generate a potential having an ideal distribution to prevent discharge.

According to another preferred embodiment, a potential applying mechanism comprises a plurality of linear electrodes exposed from the holding surface and arranged in the traveling direction at a regular pitch, each extending in a direction orthogonal to the traveling direction, an insulator interposed among the plurality of linear electrodes to form the holding surface together with the linear electrodes, a plurality of resistance elements each for connecting adjacent two of the plurality of linear electrodes, and a potential applying electrode shift mechanism for applying a first potential to one of the plurality of linear electrodes which is located at the transfer position, applying a second potential which is nearer to a surface potential of the loop member than the first potential to one of the plurality of linear electrodes which is located away from the transfer position at a predetermined distance in the traveling direction or a direction opposite to the traveling direction, and sequentially shifting the linear electrode to which the first potential is applied and the linear electrode to which the second potential is applied in synchronization with the movement of the substrate holding part.

In the above two preferable potential applying mechanisms, a second potential which is nearer to a surface potential of the loop member than the first potential may be applied to ones of the plurality of linear electrodes which are located away from the transfer position at a predetermined distance toward the traveling direction and a direction opposite to the traveling direction. With this, the difference between the surface potential of the loop member and the potential of the holding surface gradually decreases as the distance from the transfer position in both directions becomes larger, and it is possible to prevent discharge from occurring in both the traveling direction side and the opposite side of the transfer position.

In the image forming apparatus, preferably, the original image is a toner image formed by applying liquid toner to an electrostatic latent image on the outer peripheral surface.

The present invention is also intended for an image forming method for forming a toner image or an electrostatic latent image on a substrate.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view showing an image forming apparatus in accordance with a first preferred embodiment;

FIG. 2 is a view showing the vicinity of a transfer position;

FIG. 3 is a flowchart showing an operation flow for forming a toner image on a glass substrate;

FIG. 4 is a graph showing a potential applied to a support belt;

FIG. 5 is a view showing another exemplary transfer part;

FIG. 6 is a view showing still another exemplary transfer part;

FIG. 7 is a view showing an image forming apparatus in accordance with a second preferred embodiment;

FIG. 8 is a view showing another case where a distribution potential is generated on a contact surface of the support belt;

FIG. 9 is a view showing still another case where a distribution potential is generated on the contact surface of the support belt;

FIG. 10 is a view showing an image forming apparatus in accordance with a third preferred embodiment;

FIG. 11 is a plan view showing a substrate holding part;

FIG. 12 is a view showing a substrate moving mechanism;

FIG. 13 is a flowchart showing an operation flow for forming a toner image on the glass substrate;

FIG. 14 is a view showing a state where a potential applying mechanism applies a potential;

FIG. 15 is a view showing an image forming apparatus in accordance with a fourth preferred embodiment;

FIG. 16 is a view showing an image forming apparatus in accordance with a fifth preferred embodiment;

FIG. 17 is a view showing another example of a plurality of linear electrodes;

FIG. 18 is a view showing still another example of a plurality of linear electrodes; and

FIG. 19 is a view showing another exemplary potential applying mechanism.

### DESCRIPTION OF THE PREFERRED EMBODIMENTS

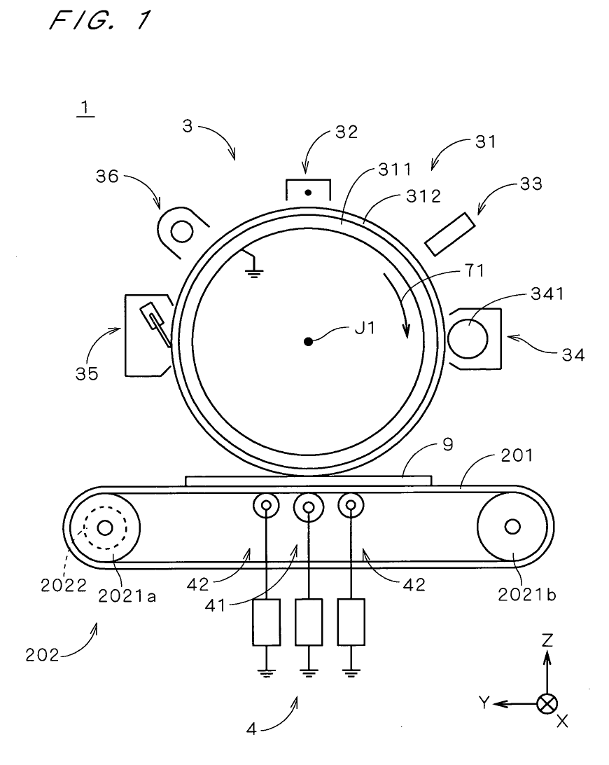

FIG. 1 is a view showing a constitution of an image forming apparatus 1 in accordance with the first preferred embodiment of the present invention. The image forming apparatus 1 of the present preferred embodiment is a printer which forms a toner image on a glass substrate, using electrophotography. The toner image is fixed on the glass substrate through a not-shown fusing unit (fixing unit) in the downstream, to manufacture a color filter for a flat panel display such as a liquid crystal display. Actually, three image forming apparatuses 1 and fusing units corresponding to the toner of three colors, i.e., R (red), G (green) and B (blue), are provided in alignment.

The image forming apparatus 1 of FIG. 1 comprises a loop support belt 201 formed of a semiconductor material having a constant thickness and two rollers 2021a and 2021b provided away from each other in the Y direction of FIG. 1, each extending in the X direction. The support belt 201 is hung on the two rollers 2021a and 2021b. A motor 2022 is connected to one roller 2021a, and driven by the motor 2022, the support belt 201 rotatingly moves around the two rollers 2021a and 2021b. On an upper (on the (+Z) side) part of the support belt 201 with respect to the two rollers 2021a and 2021b, a glass substrate 9 having a thickness of e.g., 0.3 to 0.7 mm is placed. The glass substrate 9 is horizontally moved in the Y direction by the rotating movement of the support belt 201 with its lower surface (its main surface on the (−Z) side) coming into contact with an outer peripheral surface of the support belt 201 (exactly, part of the outer peripheral surface toward the (+Z) direction on an upper part of the support belt 201 with respect to the rollers 2021a and 2021b, and hereinafter this part of the outer peripheral surface is referred to as a “contact surface”) and being supported by the outer peripheral surface. In the image forming apparatus 1, the two rollers 2021a and 2021b and the motor 2022 constitute a substrate moving mechanism 202 for moving the glass substrate 9 on the support belt 201.

The image forming apparatus 1 further comprises a process unit 3 which is so provided as to face the glass substrate 9 on the support belt 201, for forming a toner image of color of R, G or B on a photosensitive drum by electrophotography, and a transfer part 4 for applying a potential to a portion of the support belt 201 which faces the process unit 3 (i.e., a portion having the contact surface).

The process unit 3 comprises a photosensitive drum (photoconductor drum) 31 having a diameter of 250 mm, which is connected to a not-shown motor through a reduction gear, and the photosensitive drum 31 is supported rotatably around a rotation axis J1 parallel to the X direction. The photosensitive drum 31 has a drum body 311 formed of metal such as aluminum, with the rotation axis J1 as its center, and the drum body 311 is electrically grounded. Onto an outer peripheral surface of the drum body 311, for example, a single-layer organic photosensitive material having phthalocyanine pigment (hereinafter, referred to simply as a “photosensitive material 312”) is uniformly applied (or vapor-deposited). The diameter of the photosensitive drum 31 is not limited to 250 mm, but preferably, it should range from 200 mm to 400 mm. The photosensitive material 312 may be formed of an inorganic photosensitive material such as amorphous silicon, other than the single-layer organic photosensitive material having phthalocyanine pigment.

The process unit 3 further has a drum charger 32 which is so provided as to face the photosensitive drum 31, and the drum charger 32 generates ion to charge the photosensitive material 312. Around the photosensitive drum 31, clockwise from the drum charger 32 arranged are a latent image forming part 33 for emitting light for image formation to form an electrostatic latent image on the photosensitive material 312, a developing part 34 for applying liquid toner (e.g., wet toner dispersed in an insulating isoparaffin solvent (carrier solvent)) to the electrostatic latent image formed on the photosensitive material 312 to develop the image, a cleaner 35 for cleaning a surface of the photosensitive material 312 and a drum discharger 36 for emitting light to remove electric charges from the photosensitive material 312. The developing part 34 is connected to a toner feeder (not shown) for supplying liquid toner which is a developing liquid.

The glass substrate 9 on the support belt 201 comes closest to the outer peripheral surface of the photosensitive material 312 between the developing part 34 and the cleaner 35 on a moving path of portions of the photosensitive material 312. As discussed later, since the toner on the outer peripheral surface of the photosensitive material 312 is transferred onto an upper surface of the glass substrate 9 at a position where the photosensitive material 312 and the glass substrate 9 come closest to each other, the position where the photosensitive material 312 and the glass substrate 9 come closest to each other is referred to as a transfer position in the following discussion and one main surface of the glass substrate 9 to which the toner is transferred is referred to simply as an upper surface (not necessarily a surface whose normal is physically directed upward). The transfer position is a position fixed relatively to the process unit 3.

The transfer part 4 has a transfer potential applying part (first potential applying part) 41 for applying a transfer potential (e.g., (+3000) V) which is the first potential to the same position as the transfer position in the Y direction on a surface of a portion of the support belt 201 on the side of the process unit 3 opposite to the contact surface and two auxiliary potential applying parts (second potential applying part) 42 for applying the second potential (e.g., (−1000) V) (hereinafter, referred to as “auxiliary potential”) to positions away from the position to which the transfer potential is applied by the transfer potential applying part 41 at the same distance (e.g., 4 cm) in the (+Y) direction and the (−Y) direction, respectively.

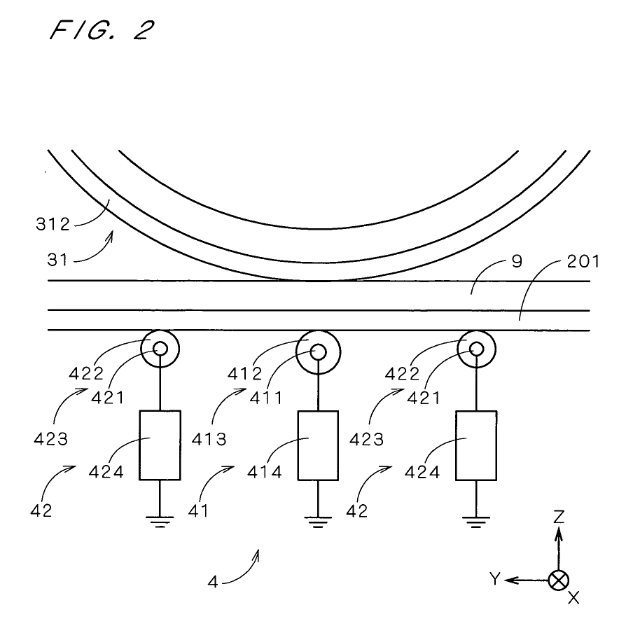

FIG. 2 shows the vicinity of the transfer position, being enlarged. As shown in FIG. 2, the transfer potential applying part 41 has an electrode 411 elongated in the X direction of FIG. 2, to which the transfer potential is applied by a transfer potential supply part 414, and the surrounding of the electrode 411 is covered with a conductive rubber 412, to form a transfer roller 413. On a surface of the support belt 201 opposite to the contact surface, the transfer roller 413 comes into contact with a position closest to the transfer position with the support belt 201 and the glass substrate 9 interposed between itself and the photosensitive drum 31. Like the transfer potential applying part 41, each of the auxiliary potential applying parts 42 has an electrode 421 elongated in the X direction, to which the auxiliary potential is applied by an auxiliary potential supply part 424, and the surrounding of the electrode 421 is covered with a conductive rubber 422, to form a roller (hereinafter, referred to as an “auxiliary roller”) 423. The auxiliary roller 423 comes into contact with a surface of the support belt 201 opposite to the contact surface at a position away from the transfer roller 413 in the Y direction. In the transfer roller 413 and the two auxiliary rollers 423, the conductive rubbers 412 and 422 are elastically deformed with the glass substrate 9 placed on the support belt 201 and potentials are thereby uniformly applied to the support belt 201 in a direction (X direction) orthogonal to the Y direction and along the upper surface of the glass substrate 9. The transfer roller 413 and the auxiliary rollers 423 may be formed by covering the electrodes 411 and 421 with conductive elastic materials other than the conductive rubbers.

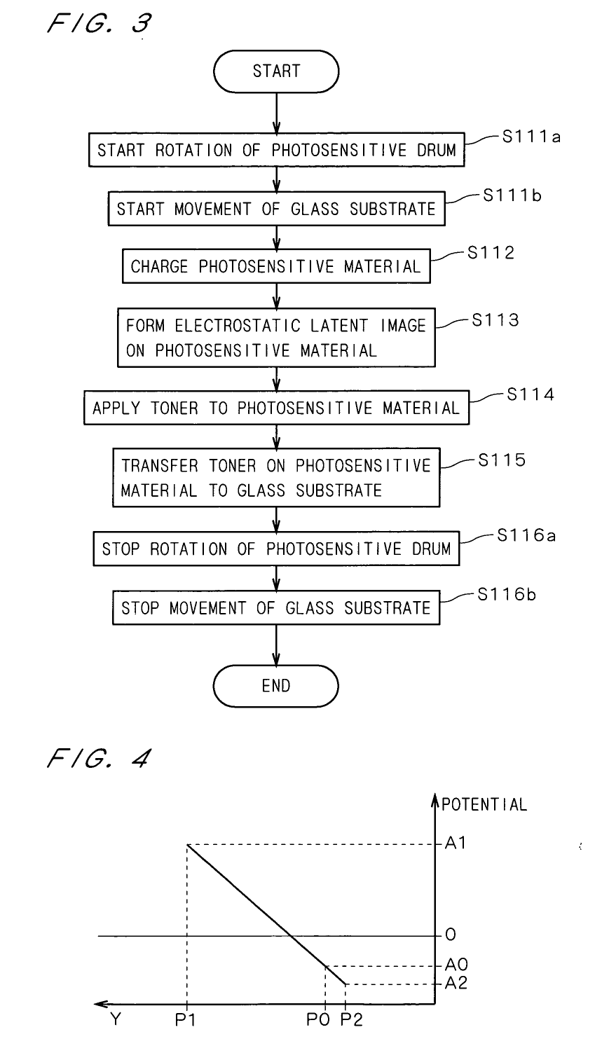

FIG. 3 is a flowchart showing an operation flow of the image forming apparatus 1 for forming a toner image on the glass substrate 9. Steps S112 to S115 of FIG. 3 show an operation flow for part of the photosensitive material 312, and for the whole of photosensitive material 312, actually, the steps are executed almost concurrently.

In the image forming apparatus 1 of FIG. 1, first, the photosensitive drum 31 starts rotating clockwise (in the rotation direction indicated by the arrow 71 of FIG. 1) around the rotation axis J1 at a constant rotation speed while the glass substrate 9 starts moving toward the (+Y) direction at a constant speed (Steps S111a and S111b). In the process unit 3, with rotation of the photosensitive drum 31, the photosensitive material 312 like a cylindrical drum with the rotation axis J1 continuously moves rotatingly for the peripheral constituents (i.e., the drum charger 32, the latent image forming part 33, the developing part 34, the cleaner 35 and the drum discharger 36), and these peripheral constituents start performing processes for the photosensitive material 312. In the glass substrate 9 of the present preferred embodiment, a lattice black matrix is formed on the upper surface (which is a surface facing the process unit 3) in advance by other device.

The drum charger 32 sequentially applies electric charges to a portion of the photosensitive material 312 which reaches a position facing it (hereinafter, referred to as a “target part”), to uniformly charge a surface of the target part with e.g., (−700) V (Step S112). The charged target part is continuously moved to an irradiation position of the latent image forming part 33. The latent image forming part 33 has an LED array in which a plurality of light emitting diodes (LEDs) for emitting light of predetermined wavelength are arranged, as a light source. The latent image forming part 33 receives image data corresponding to the color of toner of the process unit 3 out of the image data of color components generated from an image indicating a pattern of color filter and emits light for image formation in accordance with this image data toward the photosensitive material 312. In the portion of the target part of the photosensitive material 312 which is irradiated with light, the electric charges on the surface are moved inside the photosensitive material 312 and removed. Since part of the photosensitive material 312 which is not irradiated with light keeps the state of being charged, an image of distribution of electric charges (i.e., an electrostatic latent image) is formed on the surface of the photosensitive material 312 (Step S113). The light source of the latent image forming part 33 is not necessarily limited to an LED but may be e.g., a semiconductor laser, combination of a lamp and a liquid crystal shutter, or the like.

The part (target part) of the photosensitive drum 31 on which the electrostatic latent image is formed is moved to a position facing the developing part 34, and then a developing roller 341 of the developing part 34 applies liquid toner (toner which is dispersed in a solvent and charged) to the electrostatic latent image (Step S114). At this time, the toner charged to have the same polarity as the surface of the photosensitive material 312 is attached to only a portion of the target part on the photosensitive material 312 in which the electric charges are removed, to develop the electrostatic latent image. In other words, a toner image is formed on the target part of the photosensitive material 312. There may be another case where the charged toner should be attached to the charged portion on the photosensitive material 312.

After that, the target part reaches the transfer position which is closest to the upper surface of the glass substrate 9 and moves exactly in the (+Y) direction at a speed in accordance with the rotation speed of the photosensitive drum 31 (the speed in a tangential direction in a section of the outer peripheral surface of the photosensitive drum 31 which is orthogonal to the rotation axis J1) at the transfer position. The substrate moving mechanism 202 moves the glass substrate 9 on the support belt 201 along the upper surface in the (+Y) direction, which is the same direction as the target part moves toward, as a traveling direction at the same speed as the target part goes at the transfer position, and the transfer roller 413 of FIG. 2 slightly presses the glass substrate 9 through the support belt 201 toward the side of the photosensitive drum 31 ((+Z) side) at the transfer position, to bring the upper surface of the glass substrate 9 into contact with the target part of the photosensitive material 312 through the toner (these two may not necessarily be brought into contact with each other, and the same applies to the following).

FIG. 4 is a graph showing a potential applied to the support belt 201 in the vicinity of the transfer position. FIG. 4 shows only a potential generated between a position P1 on the support belt 201 in the Y direction with which the transfer roller 413 comes into contact and a position P2 thereon in the Y direction with which the auxiliary roller 423 on the (−Y) side comes into contact.

As discussed earlier, since the transfer potential applying part 41 applies a positive transfer potential to the support belt 201 and the auxiliary potential applying part 42 applies a negative auxiliary potential having the polarity reverse to that of the transfer potential to the support belt 201, a constant current is carried from the transfer roller 413 to the auxiliary roller 423 through the semiconductor support belt 201 having a constant thickness. At this time, in the support belt 201, the difference between the potential at the transfer position and the potential at a position away from the transfer position in the Y direction (i.e., voltage) is the product of the resistance in a range from the transfer position of the support belt 201 to this position and the current flowing in the support belt 201, and the resistance in this range is proportional to the distance from the transfer position to this position in the Y direction. Therefore, as shown in FIG. 4, the potential applied to each portion in the support belt 201 linearly decreases from a transfer potential A1 to an auxiliary potential A2 as this portion goes from the position P1 with which the transfer roller 413 comes into contact toward the position P2 with which the auxiliary roller 423 on the (−Y) side comes into contact in the Y direction (in the other words, a potential gradient is formed in the support belt 201).

Since the auxiliary potential A2 is nearer to a surface potential A0 of the photosensitive material 312 than the transfer potential A1, a potential having a distribution where (the absolute value of) the difference between the potential and the surface potential of the photosensitive material 312 gradually decreases as the distance from the transfer position P1 toward the (−Y) direction becomes larger (hereinafter, the potential indicating the whole distribution generated in the support belt 201 is referred to as a “distribution potential”) is generated on the contact surface of the support belt 201 and this distribution potential is given to a (lower) surface of the glass substrate 9 opposite to the upper surface thereof. In the present preferred embodiment, since the surface potential A0 of the photosensitive material 312 takes a value between the value of the transfer potential A1 and that of the auxiliary potential A2, a range of the distribution potential where the difference between the potential and the surface potential of the photosensitive material 312 gradually decreases as the distance from the transfer position P1 in the (−Y) direction becomes larger (hereinafter, referred to as a “potential difference decreasing range”) is exactly from the transfer position P1 to a position P0 where the potential becomes A0. If the auxiliary potential takes a value between the value of the transfer potential and that of the surface potential of the photosensitive material 312, the potential difference decreasing range is from the transfer position P1 to the position P2 with which the auxiliary roller 423 on the (−Y) side comes into contact.

With the above distribution potential, on the upper surface of the glass substrate 9, a potential having a polarity reverse to that of the toner is generated at the transfer position, and the toner on the target part of the photosensitive material 312 is thereby moved to the upper surface of the glass substrate 9 (Step S115). In the potential difference decreasing range in the vicinity of the transfer position, since the difference between the surface potential of the photosensitive material 312 and the potential on the upper surface of the glass substrate 9, i.e., a voltage (bias) which is applied to a gap between the outer peripheral surface of the photosensitive material 312 and the upper surface of the glass substrate 9 gradually decreases as the distance from the transfer position toward the (−Y) direction becomes larger and the width of the gap gradually increases, the electric field in this gap sharply decreases as the distance from the transfer position toward the (−Y) direction becomes larger. In the image forming apparatus 1, the potential on the (+Y) side of the transfer position has the same distribution as the above, and it is therefore possible to prevent (or suppress) the discharge caused by a phenomenon in which the electric field applied to the gap between the outer peripheral surface of the photosensitive material 312 and the upper surface of the glass substrate 9 in the vicinity of the transfer position on both (+Y) and (−Y) sides becomes an electric breakdown field of this gap or higher.

The target part is continuously moved to the position of the cleaner 35 of FIG. 1 and the cleaner 35 cleans the surface of the photosensitive material 312 by removing unnecessary substances such as toner remaining on the target part of the photosensitive material 312 (in other words, toner not transferred to the glass substrate 9) and the photosensitive material 312 is thereby mechanically turned back to the initial state. Then, the photosensitive material 312 is irradiated with light by the drum discharger 36 having combination of a lamp and a filter, or an LED or the like, to be cleared of electric charges, and electrically turned back to the initial state.

Since the operations of Steps S112 to S115 are performed almost concurrently on the portions on the photosensitive material 312 and each of the operations is continuously performed on the portions of the photosensitive material 312 which sequentially reach the transfer position, the whole of toner image on the outer peripheral surface of the photosensitive material 312 is eventually transferred to the upper surface of the glass substrate 9 at the transfer position. When printing on the whole of glass substrate 9 is completed, the rotation of the photosensitive drum 31 is stopped and the substrate moving mechanism 202 is also stopped, and this puts an end to the printing operation of the image forming apparatus 1 (Steps S116a and S116b). Thus, a toner image of one color is completely formed entirely on the upper surface of the glass substrate 9.

As discussed earlier, actually, three image forming apparatus 1 corresponding to the three colors, R, G and B, are prepared, and when formation of the toner image of one color is completed on the glass substrate 9, the glass substrate 9 is carried to the next image forming apparatus for formation of a toner image of next color. With this operation, the toner image of three colors, R, G and B is formed on the glass substrate 9 by the three image forming apparatus and finally fused by heating with a fusing unit to be fixed on the glass substrate 9. Then, a color filter is completed.

Depending on, however, the design of the image forming apparatus and the setting condition such as the distance between the transfer roller 413 and the auxiliary roller 423 in the Y direction or the magnitude of the transfer potential and the auxiliary potential, there is a possible case where the electric field applied to the close vicinity of the transfer position should become an electric breakdown field or higher in the gap between the outer peripheral surface of the photosensitive material 312 and the upper surface of the glass substrate 9. Even if such a design or a setting condition can not be avoided, it is possible to prevent discharge from occurring between the outer peripheral surface of the photosensitive material 312 and the upper surface of the glass substrate 9 in the close vicinity of the transfer position by making the carrier solvent of liquid toner full (the same applies to the image forming apparatuses discussed later). From such a viewpoint, it is preferable that the toner image formed by the image forming apparatus 1 should be formed by applying liquid toner to the electrostatic latent image on the outer peripheral surface of the photosensitive material 312. It is natural, depending on the design of the image forming apparatus and the setting condition, that powder toner (toner which is charged, not being dispersed in a carrier solvent) may be used.

As discussed above, in the image forming apparatus 1 of FIG. 1, when the toner image on the photosensitive material 312 is transferred to the upper surface of the glass substrate 9 at the transfer position, the potential having the distribution where the difference between the potential and the surface potential of the photosensitive material 312 gradually decreases as the distance from the transfer position toward both the (+Y) and (−Y) directions becomes larger is given to the glass substrate 9 through the support belt 201 by the transfer part 4. This makes it possible to prevent discharge from occurring between the photosensitive material 312 and the glass substrate 9 in the vicinity of the transfer position, which would disturb the toner image on the outer peripheral surface of the photosensitive material 312 which is to be transferred or the toner image transferred on the upper surface of the glass substrate 9, and as a result, the toner image can be transferred onto the glass substrate 9 with high accuracy.

Further in the image forming apparatus 1, since the auxiliary potential applied to the support belt 201 by the auxiliary potential applying part 42 has a polarity reverse to that of the transfer potential applied by the transfer potential applying part 41, the distribution potential having sharper gradient than that in a case where the transfer potential and the auxiliary potential have the same polarity is generated in the support belt 201, and it is therefore possible to further prevent discharge from occurring in the gap between the photosensitive material 312 and the glass substrate 9 in the vicinity of the transfer position.

FIG. 5 is a view showing another exemplary transfer part. In a transfer part 4a of FIG. 5, instead of the transfer potential applying part 41 having the transfer roller 413 of FIG. 2, a transfer potential applying part 41a having a DC corona discharger 415 is provided. To a discharge wire of the corona discharger 415, the transfer potential supply part 414 is connected.

When the toner image on the outer peripheral surface of the photosensitive material 312 is transferred onto the glass substrate 9 at the transfer position, electric charges (discharge ions) are applied by the corona discharger 415 to a position on a surface of the support belt 201 opposite to the contact surface, which is closest to the transfer position with the support belt 201 and the glass substrate 9 interposed between itself and the photosensitive drum 31, and the transfer potential is thereby applied to the position in a manner out of contact with the support belt 201. With this operation, a potential having a distribution where the difference between the potential and the surface potential of the photosensitive material 312 gradually decreases as the distance from the transfer position toward both the (+Y) and (−Y) directions becomes larger is generated in the support belt 201 and is applied to a surface of the glass substrate 9 opposite to the upper surface. As a result, discharge is prevented from occurring in the gap between the photosensitive material 312 and the glass substrate 9 in the vicinity of the transfer position and it is thereby possible to transfer the toner image onto the glass substrate 9 with high accuracy.

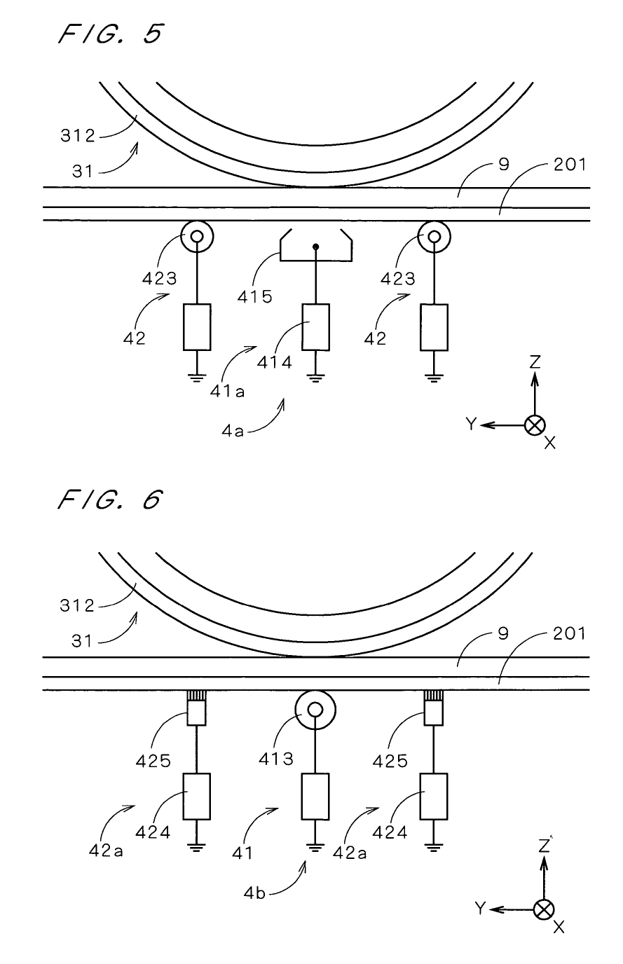

FIG. 6 is a view showing still another exemplary transfer part. In a transfer part 4b of FIG. 6, instead of the auxiliary potential applying parts 42 each having the auxiliary roller 423 shown in FIG. 2, auxiliary potential applying parts 42a each having a brush 425 formed of a conductive material are provided. The auxiliary potential supply part 424 is connected to each brush 425, and the brushes 425 come into contact with positions on a surface of the support belt 201 opposite to the contact surface, which are away from the transfer roller 413 at a predetermined distance in the (+Y) and (−Y) directions, and the auxiliary potentials are thereby applied to these positions. Thus, in the image forming apparatus of FIG. 6, by using the brush 425 instead of the auxiliary roller 423, the construction of the auxiliary potential applying part can be simplified and it is possible to prevent discharge from occurring in the gap between the photosensitive material 312 and the glass substrate 9 in the vicinity of the transfer position and transfer the toner image onto the glass substrate 9 with high accuracy.

The transfer roller 413 or the auxiliary roller 423 is provided in the transfer potential applying part 41 and the two auxiliary potential applying parts 42 in the transfer part 4 of FIG. 1, in the two auxiliary potential applying parts 42 in the transfer part 4a of FIG. 5 and only in the transfer potential applying part 41 in the transfer part 4b of FIG. 6. Thus, since a roller is provided in at least one of the transfer potential applying part and the two auxiliary potential applying parts in the above image forming apparatus, with the roller elastically deformed in the transfer potential applying part 41 or the auxiliary potential applying part 42 having the roller, a potential can be applied to the support belt 201 stably and appropriately. If a potential can be applied to the support belt 201 appropriately, in the potential applying part with no roller, a roller formed of metal or a semiconductor material, a metal contact segment or the like may be provided.

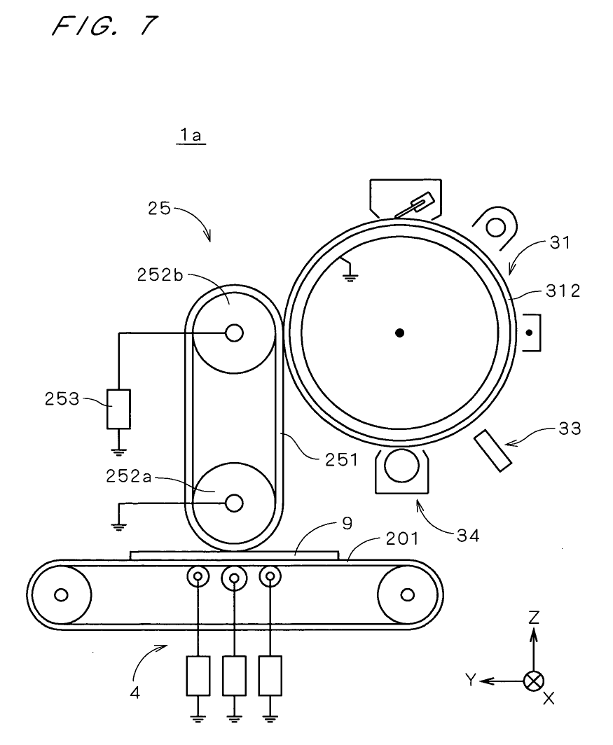

FIG. 7 is a view showing a constitution of an image forming apparatus 1a in accordance with the second preferred embodiment. In the image forming apparatus 1a of FIG. 7, an intermediate transfer part 25 having an intermediate transfer member 251 is provided and a toner image on the photosensitive drum 31 is transferred onto the glass substrate 9 indirectly through the intermediate transfer member 251. Specifically, the intermediate transfer member 251 is a loop member like a flat belt, which is formed of a dielectric material, and so provided as to be externally in contact with two rollers 252a and 252b. A motor is connected to one roller 252a, and with the motor driven, the intermediate transfer member 251 comes into contact with a portion of the photosensitive drum 31 where the toner image is formed while rotatingly moving along the outer peripheral surface. A DC power supply 253 is connected to the other roller 252b. In the image forming apparatus 1a of FIG. 7, the toner image formed on the photosensitive material 312 by the latent image forming part 33, the developing part 34 and the like is transferred onto the intermediate transfer member 251 which is rotatingly moved by a potential applied through the roller 252b. The portion of the intermediate transfer member 251 on which the toner image is formed is moved to the glass substrate 9. Then, the transfer part 4 applies a potential between the intermediate transfer member 251 and the glass substrate 9 while preventing discharge in the vicinity of the transfer position, to thereby transfer the toner image on the intermediate transfer member 251 onto the glass substrate 9.

In the image forming apparatus 1a of FIG. 7, the glass substrate 9 is moved in the (−Y) direction of FIG. 7 in image formation. In the image forming apparatuses 1 and 1a, there may be a case where the developing part 34 is omitted and the transfer part 4 applies the transfer potential having a polarity reverse to that of the electric charges of the electrostatic latent image to the glass substrate 9 while transferring the electrostatic latent image on the photosensitive material 312 or the electrostatic latent image transferred onto the intermediate transfer member 251 from the photosensitive material 312 onto the glass substrate 9.

Thus, in the image forming apparatuses 1 and 1a, the photosensitive drum 31 or the intermediate transfer part 25 operates as an original image holding part which rotatingly moves the loop member like a cylindrical drum or a flat belt along its outer peripheral surface on which an original image which is the toner image or the electrostatic latent image to be transferred to the glass substrate 9 is formed and the original image which is an object to be transferred to the glass substrate 9 is thereby moved to the transfer position and transferred onto the glass substrate 9. There may be another case where a multistylus which is a set of pin electrodes is provided as the latent image forming part and a loop member formed of a dielectric material is provided in the original image holding part and a voltage is applied to the pin electrodes which face the outer peripheral surface of the loop member with a gap interposed therebetween to cause discharge between the tips of the pin electrodes and the loop member, and the electric charges are thereby applied to the outer peripheral surface of the loop member to form an electrostatic latent image.

Though the image forming apparatuses 1 and 1a of the first and second preferred embodiments have been discussed above, the image forming apparatuses 1 and 1a allow various variations other than the above examples.

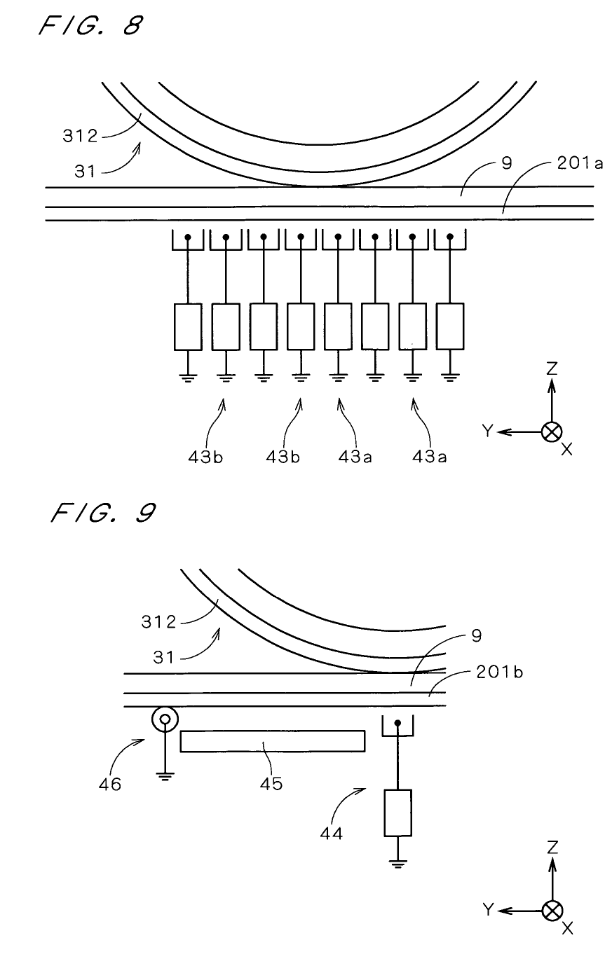

In the first and second preferred embodiments, the transfer potential and the auxiliary potential are applied to the semiconductor support belt 201 to cause the distribution potential in the support belt 201, which has a distribution where the difference between the potential and the surface potential of the photosensitive material 312 gradually decreases as the distance from the transfer position in the Y direction becomes larger, and thus the distribution potential can be easily applied to a surface of the glass substrate 9 opposite to the upper surface. In the image forming apparatuses 1 and 1a, however, another technique may be used to cause the distribution potential in the contact surface of the support belt. In an image forming apparatus of FIG. 8, for example, a loop-shaped support belt 201a having the same shape as the support belt 201 of FIG. 1, which is formed of an insulating material having a constant thickness, is provided and inside the support belt 201a, a plurality of DC corona dischargers for applying electric charges to the support belt 201a are provided, being aligned in the Y direction. Each of the corona dischargers 43a provided on the (−Y) side relative to the transfer position in the Y direction applies positive electric charges of predetermined amount per unit time to a surface opposite to the contact surface of the support belt 201a which rotatingly moves and each of the corona dischargers 43b provided on the (+Y) side relative to the transfer position applies negative electric charges of predetermined amount per unit time to the surface. In the image forming apparatus of FIG. 8, the distribution potential where the difference between the potential and the surface potential of the photosensitive material 312 gradually decreases as the distance from the transfer position in both (+Y) and (−Y) directions becomes larger is generated on the contact surface of the support belt 201a and given to the surface of the glass substrate 9 opposite to the upper surface. There may be a case where a plurality of corona dischargers 43b provided on the (+Y) side relative to the transfer position serve as a plurality of ionizers to remove more electric charges on the support belt 201a as the distance from the transfer position toward the (+Y) direction becomes larger.

As still another exemplary technique to generate the distribution potential on the contact surface of the support belt, in an image forming apparatus of FIG. 9, a loop-shaped support belt 201b having the same shape as the support belt 201 of FIG. 1, which is formed of a photosensitive material, is provided and inside the support belt 201b, a DC corona discharger 44 for applying electric charges to a position of the support belt 201b which is closest to the transfer position is provided. On the (+Y) side of the corona discharger 44 provided is an irradiation part 45 for emitting light having uniform intensity toward a surface of the support belt 201b opposite to the contact surface in the Y direction in a certain range, and the support belt 201b is electrically grounded through a conductive roller 46 in the vicinity on the (+Y) side of an area on the support belt 201b to which the light is emitted by the irradiation part 45. In portions of the support belt 201b, with rotating movement of the support belt 201b, the amount of applied light (the cumulative amount of applied light) gradually increases as the distance from the transfer position in the (+Y) direction becomes larger. In the image forming apparatus of FIG. 9, the electric charges applied by the corona discharger 44 below the transfer position are moved inside the support belt 201b and then removed, by emitting light to the support belt 201b. At this time, since the amount of electric charges moving inside the support belt 201b increases with the amount of applied light as the distance from the transfer position in the (+Y) direction becomes larger, in the image forming apparatus, the distribution potential having the distribution where the difference between the potential and the surface potential of the photosensitive material 312 gradually decreases as the distance from the transfer position in the (+Y) direction becomes larger is generated on the contact surface of the support belt 201b and given to a lower surface of the glass substrate 9 opposite to the upper surface. In the image forming apparatus of FIG. 9, in a gap, on the (−Y) side of the transfer position, between the photosensitive material 312 and the glass substrate 9, as necessary, discharge is prevented by making the carrier solvent of liquid toner full, and so on.

Thus, in the image forming apparatus, a transfer part for applying a distribution potential to the glass substrate 9 can be realized with various constitutions. Though the support belt 201 can stably and appropriately support even a large-size glass substrate 9 by bring its contact surface into contact with the lower surface of the glass substrate 9 opposite to the upper surface in the above preferred embodiments, in order to hold an outer edge of the glass substrate 9 or support the glass substrate 9 by a plurality of rollers each extending in the X direction, which are arranged in the Y direction, and the like, a transfer part which directly applies the distribution potential to the lower surface of the glass substrate 9 may be provided.

Though the auxiliary potential having a polarity reverse to that of the transfer potential is applied to the support belt 201 by the auxiliary roller 423 (or the brush 425) of the auxiliary potential applying part 42 in the above first and second preferred embodiments, there may be another case where the auxiliary potential supply part 424 is omitted and the auxiliary roller 423 is grounded in the auxiliary potential applying part 42, to apply a ground potential to the support belt 201 as the auxiliary potential. This makes it possible to simplify the construction of the auxiliary potential applying part 42 and apply the distribution potential having a sharp gradient to the glass substrate 9.

Though the distribution potential having the distribution where the difference between the potential and the surface potential of the photosensitive material 312 gradually decreases as the distance from the transfer position on both sides of the transfer position in the Y direction parallel to the traveling direction of the glass substrate 9 in image formation becomes larger is given to the glass substrate 9 in the above first and second preferred embodiments, the distribution potential may be given only to the (+Y) side or the (−Y) side of the transfer position. From the viewpoint that the toner image should be transferred from the photosensitive material 312 to the glass substrate 9 with high accuracy, however, it is preferable that the distribution potential having like distribution where the difference between the potential and the surface potential of the photosensitive material 312 gradually decreases as the distance from the transfer position toward not only one direction but also the opposite direction becomes larger should be given to the glass substrate 9 and the discharge should be prevented from occurring in the gap between the photosensitive material 312 and the glass substrate 9 on both the (+Y) and (−Y) sides of the transfer position, like in the above first and second preferred embodiments.

In the image forming apparatuses 1 and 1a, a stage formed of e.g., a semiconductor material having a constant thickness, on which the glass substrate 9 is placed, may be provided, where the transfer part 4 generates the distribution potential. In this case, the substrate moving mechanism is realized as a mechanism which horizontally moves the stage in the Y direction with a linear motor, combination of a ball screw mechanism and a motor or the like. Thus, as a supporting member having a contact surface which comes into contact with the glass substrate 9 in the vicinity of the transfer position and a moving mechanism for moving the glass substrate 9 in the tangential direction of the loop-shaped photosensitive material 312 (or the intermediate transfer member 251) at the transfer position where the glass substrate 9 comes closest to the outer peripheral surface of the photosensitive material 312, various elements may be used. Depending on the design of the image forming apparatus 1 or 1a, there may be a case where the glass substrate 9 is fixed and the transfer part and the process unit are moved relatively to the glass substrate 9 in the Y direction, to form the toner image on the glass substrate 9.

The image forming apparatuses 1 and 1a may be used for some purposes other than manufacture of color filters, and an object to be processed in the image forming apparatus 1 or 1a may be a semiconductor substrate, a printed circuit board or the like, other than the glass substrate 9. In the image forming apparatuses 1 and 1a, since the discharge in the vicinity of the transfer position is prevented, even if a substrate having low capacitance, which is formed of a thick material or a material whose relative dielectric constant is low, is an object, it is possible to transfer and form a toner image or an electrostatic latent image on the substrate with high accuracy by applying a high transfer potential. Thus, substrates of various materials can be processed.

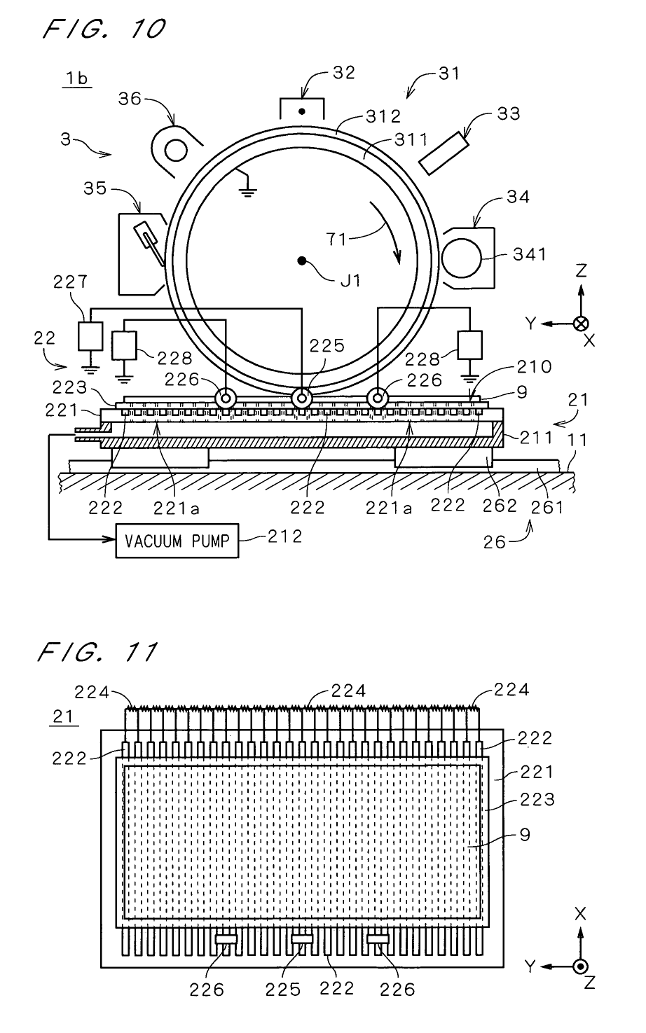

FIG. 10 is a view showing a constitution of an image forming apparatus 1b in accordance with the third preferred embodiment of the present invention. The image forming apparatus 1b is also a printer which forms a toner image on a glass substrate, using electrophotography, and the toner image is fixed on the glass substrate through a not-shown fusing unit in the downstream, to manufacture a color filter for a flat panel display such as a liquid crystal display. Actually, three image forming apparatuses 1b and fusing units corresponding to the toner of three colors, i.e., R (red), G (green) and B (blue), are provided in alignment.

The image forming apparatus 1b comprises a substrate holding part 21 for holding a lower surface (a main surface on the (−Z) side) of the glass substrate 9 having a thickness of e.g., 0.3 to 0.7 mm by vacuum adsorption with a flat holding surface 210, a substrate moving mechanism 26 provided on a surface block 11, for horizontally moving the substrate holding part 21 in the Y direction of FIG. 1 and the process unit 3 facing the glass substrate 9 on the substrate holding part 21, for forming a toner image of one color of R, G or B to be transferred, on an outer peripheral surface of a photosensitive drum by electrophotography. The substrate holding part 21 comprises a potential applying mechanism 22 provided on the holding surface 210, which applies a potential having a predetermined distribution in order to transfer the toner image to the glass substrate 9 from the photosensitive drum.

The process unit 3 is the same as that in the first preferred embodiment and comprises the photosensitive drum 31 having the drum body 311 and the photosensitive material 312. The photosensitive drum 31 is supported rotatably around the rotation axis J1 in parallel to the X direction of FIG. 1. In the process unit 3, around the photosensitive drum 31, the drum charger 32, the latent image forming part 33, the developing part 34, the cleaner 35 and the drum discharger 36 are arranged in this order.

Like in the first preferred embodiment, the glass substrate 9 on the substrate holding part 21 comes closest to the outer peripheral surface of the photosensitive material 312 between the developing part 34 and the cleaner 35 in the moving path of portions of the photosensitive material 312, and this position is the transfer position where the toner on the outer peripheral surface of the photosensitive material 312 is transferred to the upper surface of the glass substrate 9. The transfer position is a position fixed relatively to the process unit 3.

FIG. 11 is a plan view showing the substrate holding part 21. As shown in FIGS. 10 and 11, the substrate holding part 21 has a plate-like insulating member 221, and a plurality of linear electrodes 222 each extending in a direction (X direction) orthogonal to the traveling direction (Y direction) of the substrate moving mechanism 26, which are arranged at a regular pitch in the traveling direction, are buried in the insulating member 221. Though the linear electrodes 222 are illustrated as thick ones in FIGS. 10 and 11 for convenience of illustration, actually, a large number of thin linear electrodes 222 (each having a width of e.g., about 1.0 mm) are buried in the insulating member 221. Though a longitudinal section of the substrate holding part 21 is shown in FIG. 10, hatches in details in the section are omitted.

Surfaces of the linear electrodes 222 and a surface of the insulating member 221 are flush with each other, and these surfaces are covered with a resistance material 223 and a surface of the resistance material 223 is the holding surface 210 for holding the glass substrate 9. The holding surface 210 is a surface formed on a member having rigidity and including the resistance material 223 and the constituents therebelow and thereby prevented from being bent by the pressure in transfer. As shown in FIG. 11, adjacent two of the linear electrodes 222 are connected to each other with a resistance element 224 and the resistance elements 224 among a plurality of linear electrodes 222 have the same resistance value. As shown in FIG. 10, a lot of through holes 221a (shown only in FIG. 10) each having a very small diameter are formed, penetrating the insulating member 221 which exists among the linear electrodes 222 (i.e., between each two of the linear electrodes) and the resistance material 223, and below the insulating member 221 provided is a holding body 211 having a cavity thereinside and being attached to the substrate moving mechanism 26. The holding body 211 is connected to a vacuum pump 212, and since the vacuum pump 212 performs suction from the through holes 221a through the inside of the holding body 211, the glass substrate 9 can be so firmly held, being adsorbed on the holding surface 210, as not to be shifted.

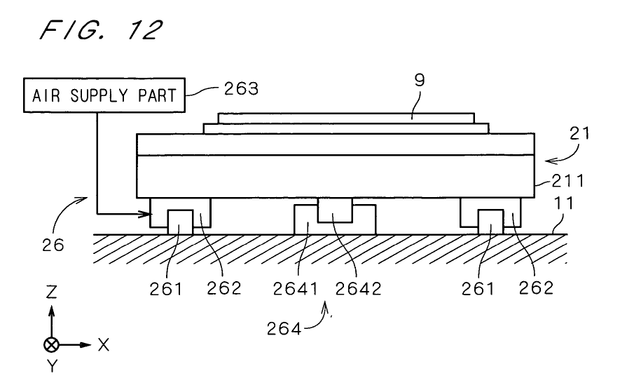

FIG. 12 is a view showing the substrate moving mechanism 26 as viewed from the (−Y) side of FIG. 10 toward the (+Y) side. The substrate moving mechanism 26 of FIGS. 10 and 12 has two guide rails 261 each extending in the Y direction, which are aligned in the X direction, on the surface block 11. Sliders 262 are attached to the holding body 211 at positions facing the guide rails 261, respectively, and supplied with high-pressure air by an air supply part 263 to be engaged with the guide rails 261 in a noncontact manner, to support the substrate holding part 21 movably in the Y direction. The substrate moving mechanism 26 further has a linear motor 264 and a fixed member 2641 of the linear motor 264 is fixed on the surface block 11 and a moving member 2642 thereof is attached to the substrate holding part 21. With the linear motor 264 driven, the substrate holding part 21 and the glass substrate 9 are moved smoothly in the Y direction.

As shown in FIG. 11, no resistance material 223 is present on the (−X) side of the substrate holding part 21 and the ends of the linear electrodes 222 are exposed. As shown in FIGS. 10 and 11, in an area where the ends of the linear electrodes 222 are exposed, a transfer potential roller (first potential applying part) 225 for applying a transfer potential which is the first potential (e.g., (+300) V) to the linear electrodes 222 located at the transfer position while coming into contact therewith and two auxiliary potential rollers (second potential applying parts) 226 away from the transfer position toward left and right are provided. The auxiliary potential rollers 226 apply the second potential (e.g., (−1000) V, hereinafter, referred to as an “auxiliary potential”) nearer to the surface potential of the photosensitive material 312 than the transfer potential to the linear electrodes 222 located away from the transfer position at a predetermined distance (e.g., 4 cm) toward the traveling direction of the substrate holding part 21 and a direction opposite to the traveling direction. The transfer potential roller 225 is connected to a transfer potential power supply 227 to apply the transfer potential and the auxiliary potential rollers 226 are connected to auxiliary potential power supplies 228 to apply the auxiliary potential. The transfer potential roller 225 and the auxiliary potential rollers 226 are positionally fixed to the surface block 11 with the not-shown supporting member, and with movement of the substrate holding part 21, the transfer potential roller 225 and the auxiliary potential rollers 226 sequentially come into contact with a plurality of linear electrodes 222, serving as a potential applying electrode shift mechanism which sequentially shifts the linear electrodes 222 to which the transfer potential and the auxiliary potential are applied.

The transfer potential roller 225 and the auxiliary potential rollers 226 are each formed by covering the surrounding of a center electrode to which the transfer potential or the auxiliary potential is applied with a conductive elastic material (e.g., rubber). With this, even if the roller is located between adjacent linear electrodes 222, the roller is deformed, to always come into contact with any one of the linear electrodes 222 while the substrate holding part 21 is moved. As a result, the transfer potential and the auxiliary potential are continuously applied to any ones of the linear electrodes 222 while the substrate holding part 21 is moved. In a case where the width of the linear electrode 222 is 1 mm and the pitch of the linear electrodes 222 is 2 mm, for example, a contact width of the transfer potential roller 225 in the Y direction is 1.1 mm or larger. If the transfer potential roller 225 comes into contact with three or more linear electrodes 222 at the same time, a high potential is disadvantageously applied to a position other than the transfer position, and it is therefore preferable that the contact width of the transfer potential roller 225 should be limited to 2.9 mm or smaller.

Since the transfer potential roller 225 and the auxiliary potential rollers 226 are each formed of an elastic material, it is possible to easily apply a desired potential to the linear electrodes 222 without giving any damage on the linear electrodes 222. Each of the transfer potential roller 225 and the auxiliary potential rollers 226 may be a conductor-type sponge roller which becomes flat across the adjacent linear electrodes 222, other than the conductive rubber roller.

The insulating member 221, the linear electrodes 222, the resistance material 223, the resistance elements 224, the transfer potential roller 225, the auxiliary potential rollers 226, the transfer potential power supply 227, the auxiliary potential power supplies 228 and the like constitute the potential applying mechanism 22 for applying a potential having a predetermined distribution for transferring the toner image from the photosensitive drum 31 to the glass substrate 9 to the holding surface 210.

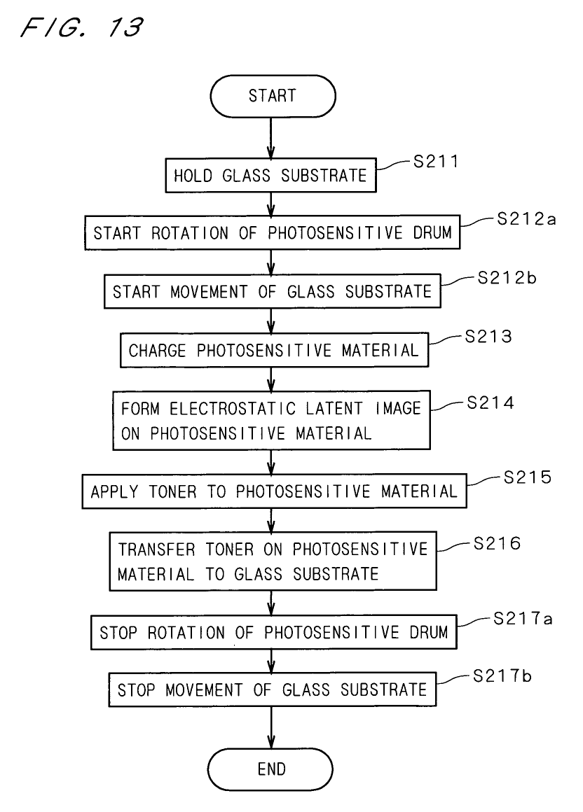

FIG. 13 is a flowchart showing an operation flow of the image forming apparatus 1b for forming a toner image on the glass substrate 9. Steps S213 to S216 of FIG. 13 show an operation flow for part of the photosensitive material 312, and for the whole of photosensitive material 312, actually, the steps are executed almost concurrently.

In the image forming apparatus 1b of FIG. 10, first, the glass substrate 9 is placed on the holding surface 210 which is an upper surface of the resistance material 223 and the vacuum pump 212 performs suction through the through holes 221a, to adsorb the glass substrate 9 onto the holding surface 210 to be held thereon (Step S211). Next, the photosensitive drum 31 starts rotating clockwise (in the rotation direction indicated by the arrow 71 of FIG. 10) around the rotation axis J1 at a constant rotation speed while the glass substrate 9 starts moving toward the (+Y) direction at a constant speed (Steps S212a and S212b). In the process unit 3, with rotation of the photosensitive drum 31, the photosensitive material 312 like a cylindrical drum with the rotation axis J1 continuously moves rotatingly for the peripheral constituents (i.e., the drum charger 32, the latent image forming part 33, the developing part 34, the cleaner 35 and the drum discharger 36), and these peripheral constituents start performing a process for the photosensitive material 312. In the glass substrate 9 of the present preferred embodiment, a lattice black matrix is formed on the upper surface (which is a surface facing the process unit 3 and not necessarily a surface whose normal is physically directed upward) which is a surface on which the image is transferred in advance by other device.

The drum charger 32 sequentially applies electric charges to a portion of the photosensitive material 312 which reaches a position facing it (hereinafter, referred to as a “target part”), to uniformly charge a surface of the target part (Step S213). The charged target part is continuously moved to an irradiation position of light from the latent image forming part 33. The latent image forming part 33 has an LED array in which a plurality of light emitting diodes (LEDs) for emitting light of predetermined wavelength are arranged, as a light source. The latent image forming part 33 receives image data corresponding to the color of toner of the process unit 3 out of the image data of color components generated from an image indicating a pattern of color filter and emits light for image formation in accordance with this image data toward the photosensitive material 312. In the portion of the target part of the photosensitive material 312 which is irradiated with light, the electric charges on the surface are moved inside the photosensitive material 312 and removed. Since part of the photosensitive material 312 which is not irradiated with light keeps the state of being charged, an image of distribution of electric charges (i.e., an electrostatic latent image) is formed on the surface of the photosensitive material 312 (Step S214). The light source of the latent image forming part 33 is not necessarily limited to an LED but may be e.g., a semiconductor laser, combination of a lamp and a liquid crystal shutter, or the like.

The part (target part) of the photosensitive drum 31 on which the electrostatic latent image is formed is moved to a position facing the developing part 34, and then the developing roller 341 of the developing part 34 applies liquid toner (toner which is dispersed in a solvent and charged) to the electrostatic latent image (Step S215). At this time, the toner charged to have the same polarity as the surface of the photosensitive material 312 is attached to only a portion of the target part on the photosensitive material 312 in which the electric charges are removed, to develop the electrostatic latent image. In other words, a toner image is formed on the target part of the photosensitive material 312. There may be another case where the toner charged to have a polarity reverse to that of the surface of the photosensitive material 312 should be attached to the charged portion on the photosensitive material 312.

After that, the target part reaches the transfer position which is closest to the upper surface of the glass substrate 9 and moves exactly in the (+Y) direction at a speed in accordance with the rotation speed of the photosensitive drum 31 (the speed in a tangential direction in a section of the outer peripheral surface of the photosensitive drum 31 which is orthogonal to the rotation axis J1) at the transfer position. The substrate moving mechanism 26 moves the glass substrate 9 along the upper surface in the (+Y) direction which is the traveling direction of the target part at the same speed as the target part goes at the transfer position, and the target part of the photosensitive material 312 thereby comes into contact with the upper surface of the glass substrate 9 at the transfer position (these two may not necessarily come into contact with each other, and the same applies to the following). At this time, a potential having a distribution discussed later is applied to a main surface (lower surface) of the glass substrate 9 opposite to the upper surface by the resistance material 223 and the linear electrodes 222 through the transfer potential roller 225 and the auxiliary potential rollers 226, and the upper surface of the glass substrate 9 thereby has a potential having a polarity reverse to that of toner at the transfer position. As a result, the toner on the target part of the photosensitive material 312 is moved to the upper surface of the glass substrate 9, to achieve a transfer using electric field (Step S216). The functions of the potential applying mechanism 22 including the transfer potential roller 225, the auxiliary potential rollers 226 and the like in transferring toner to the glass substrate 9 will be discussed in detail after the description of the whole operation of the image forming apparatus 1b.

The target part is continuously moved to the position of the cleaner 35 and the cleaner 35 cleans the surface of the photosensitive material 312 by removing unnecessary substances such as toner remaining in the target part of the photosensitive material 312 (in other words, toner not transferred to the glass substrate 9) and the photosensitive material 312 is thereby mechanically turned back to the initial state. Then, the photosensitive material 312 is irradiated with light by the drum discharger 36 having combination of a lamp and a filter, or an LED or the like, to be cleared of electric charges, and electrically turned back to the initial state.

Since the operations of Steps S213 to S216 are performed almost concurrently on the portions on the photosensitive material 312 and each of the operations is continuously performed on the portions of the photosensitive material 312 which sequentially reach the transfer position, the whole of toner image on the outer peripheral surface of the photosensitive material 312 is eventually transferred to the upper surface of the glass substrate 9 at the transfer position. When printing on the whole of glass substrate 9 is completed, the rotation of the photosensitive drum 31 is stopped and the substrate moving mechanism 26 is also stopped, and this puts an end to the printing operation of the image forming apparatus 1b (Steps S217a and S217b). Thus, a toner image of one color is completely formed entirely on the upper surface of the glass substrate 9.

As discussed earlier, actually, three image forming apparatuses corresponding to the three colors, R, G and B, are prepared, and when formation of the toner image of one color is completed on the glass substrate 9, the glass substrate 9 is carried to the next image forming apparatus for formation of a toner image of next color. With this operation, the toner image of three colors, R, G and B is formed on the glass substrate 9 by the three image forming apparatuses and finally fused by heating with the fusing unit to be fixed on the glass substrate 9. Then, a color filter is completed.

Next, detailed discussion will be made on a function of the potential applying mechanism 22 in the image forming apparatus 1b, referring to FIG. 14. The upper side of FIG. 14 shows the distribution of potentials formed on a lower surface of the resistance material 223 (upper surfaces of the insulating member 221 and the linear electrodes 222) and the lower side of FIG. 14 shows the state of contacts between a plurality of linear electrodes 222 and the transfer potential roller 225 and the auxiliary potential rollers 226, corresponding to the distribution of potentials. In FIG. 14, the linear electrode 222 which comes into contact with the transfer potential roller 225 at the transfer position is represented by reference sign 222a and the linear electrodes 222 which come into contact with the auxiliary potential rollers 226 at positions away from the linear electrode 222a at a predetermined distance are represented by reference sign 222b.

The auxiliary potential applied by the auxiliary potential roller 226 is a potential having a polarity reverse to that of the transfer potential as shown in FIG. 14 (that may be a ground potential), and the potential difference generated between the linear electrode 222a and the linear electrode 222b carries a current in a plurality of (hereinafter, “n”) resistance elements 224 connected in series between the linear electrode 222a and the linear electrode 222b. As a result, on an upper surface of the insulating member 221 and the linear electrodes 222 between the transfer potential roller 225 and the auxiliary potential roller 226 formed is a distribution of potentials which changes by 1/n of the potential difference between the rollers 225 and 226 at every pitch of the linear electrodes 222 as shown in the upper side of FIG. 14.

Thus, the potential having the distribution where the difference between the potential and the surface potential of the photosensitive material 312 gradually decreases as the distance from the transfer position toward the traveling direction of the substrate holding part 21 and its opposite direction becomes larger is given to a surface (lower surface) of the glass substrate 9 opposite to the upper surface through the holding surface 210. As a result, also on the upper surface of the glass substrate 9, the potential having the distribution where the difference between the potential and the surface potential of the photosensitive material 312 gradually decreases as the distance from the transfer position toward the traveling direction of the substrate holding part 21 and its opposite direction becomes larger is (indirectly) given. Since the gap between the outer peripheral surface of the photosensitive material 312 and the upper surface of the glass substrate 9 gradually increases as the distance from the transfer position becomes larger, the electric field in the gap sharply becomes small as the distance from the transfer position becomes larger. As a result, it is possible to prevent (or suppress) the discharge caused by a phenomenon in which the electric field in the gap between the outer peripheral surface of the photosensitive material 312 and the glass substrate 9 becomes an electric breakdown field of this gap or higher in the vicinity of the transfer position, and the toner image can be thereby transferred to the glass substrate 9 with high accuracy.

The potential on the photosensitive drum 31 may be one between the transfer potential and the auxiliary potential, and in this case, the potential having the distribution where the difference between the potential and the surface potential of the photosensitive material 312 gradually decreases as the distance from the transfer position becomes larger until some midpoint in a range from the transfer potential roller 225 to the auxiliary potential roller 226 is given to the upper surface of the glass substrate 9. Since the upper surface of the insulating member 221 is covered with the resistance material 223 and the glass substrate 9 is held thereon, actually, in the distribution of the potential on the upper surface of the glass substrate 9, the maximum value and the minimum value of the potential approximate to the ground potential, as compared with the distribution of the potentials shown in the upper side of FIG. 14, and the step differences in potential at respective positions of the linear electrodes 222 become smoother.

The resistance value of the resistance element 224 should be a value lower than the resistance value of the resistance material 223 between adjacent two linear electrodes 222 (not lower than 10³Ω and not higher than 10⁹Ω, preferably not lower than 10⁵Ω and not higher than 10⁹Ω, e.g., 10⁸Ω). This makes the current more easily flow in the resistance element 224, to stably form a desired distribution of potential on the upper surface. By covering the surfaces of the linear electrodes 222 with the resistance material 223, it is possible to easily form a potential having an ideal smooth distribution to prevent the discharge, and even when the transfer potential roller 225 is located between adjacent two linear electrodes 222, it is possible to easily uniformize a local distribution of potential at the transfer position. If a stable distribution of potential can be formed, naturally, the resistance element 224 may be omitted.

When the substrate holding part 21 is moved by the substrate moving mechanism 26 in the traveling direction ((+Y) direction) with the above distribution of potential formed, in synchronization with the movement of the substrate holding part 21, the linear electrodes 222 to which the transfer potential and the auxiliary potential are applied are sequentially shifted relatively in the (−Y) direction while the relative relation in position between the transfer potential roller 225 and the auxiliary potential roller 226 is maintained, and the distribution of potential formed around the transfer position is maintained. As a result, the whole of toner image can be stably transferred from the photosensitive drum 31 to the glass substrate 9.

As discussed above, in the image forming apparatus 1b of the present preferred embodiment, since the glass substrate 9 is held on the flat holding surface 210 formed on a member having rigidity, it is possible to transfer the toner image from the photosensitive drum 31 to the glass substrate 9 with high accuracy, preventing a shift of the glass substrate 9. Further, since the potential having the distribution where the difference between the potential and the surface potential of the photosensitive drum 31 gradually decreases as the distance from the transfer position becomes larger is given to the upper surface of the glass substrate 9, it is possible to prevent discharge from occurring on the traveling direction side of the transfer position and the opposite side and therefore possible to prevent disturbance in the toner image transferred on the glass substrate 9 and the toner image on the photosensitive material 311 which is to be transferred.

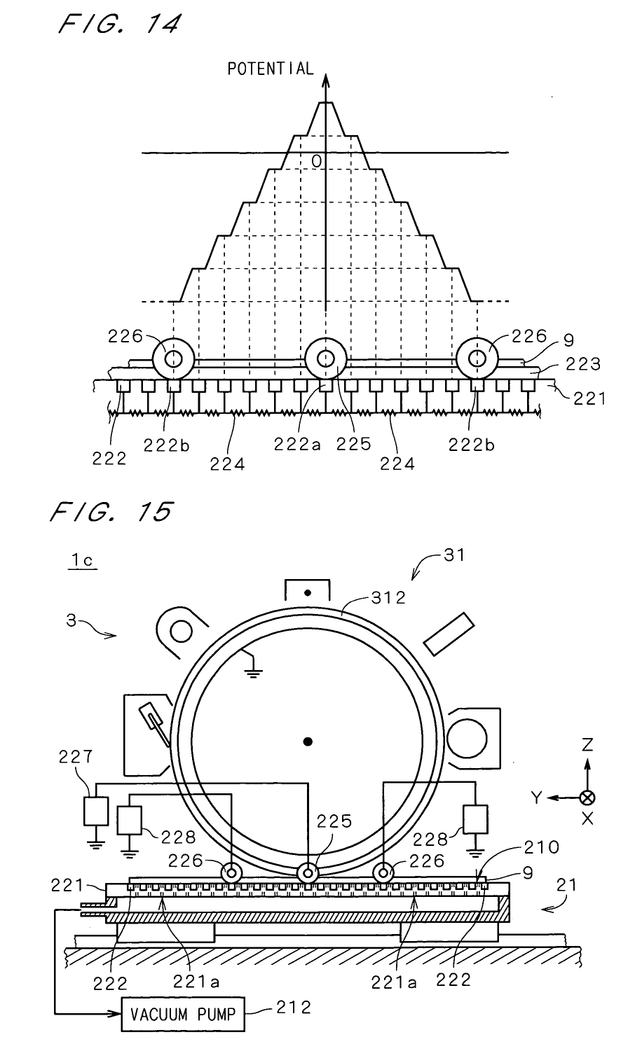

FIG. 15 is a view showing an image forming apparatus 1c in accordance with the fourth preferred embodiment of the present invention. The image forming apparatus 1c has a constitution in which the resistance material 223 is omitted from the image forming apparatus 1b of FIG. 10 and other constituent elements are the same as those in the image forming apparatus 1b of FIG. 10 and represented by the same reference signs as those in FIG. 10. Specifically, in the image forming apparatus 1c, a plurality of linear electrodes 222 each extending in a direction orthogonal to the traveling direction of the substrate holding part 21, which are arranged in the traveling direction at a regular pitch, are exposed from the holding surface 210, and the insulating member 221 is present between adjacent linear electrodes 222 and the insulating member 221 and a plurality of linear electrodes 222 form the flat holding surface 210. The holding surface 210 is a surface formed on a member having rigidity and including the linear electrodes 222, the insulating member 221 and the like and thereby prevented from being bent by pressure in transfer. Then, the vacuum pump 212 performs suction through a lot of through holes 221a each having a very small diameter and penetrating the insulating member 221 which is interposed among a plurality of linear electrodes 222, and the glass substrate 9 is thereby so held on the holding surface 210 by adsorption as not to be shifted.

For manufacturing a color filter in the image forming apparatus 1c, like in the image forming apparatus 1b of FIG. 10, after the glass substrate 9 is held on the holding surface 210 which is the upper surfaces of the insulating member 221 and the linear electrodes 222 (FIG. 13: Step S211) and the photosensitive drum 31 starts rotating and the glass substrate 9 starts being moved (Steps S212a and S212b), the charged photosensitive material 312 is irradiated with light to form an electrostatic latent image (Step S213 and S214) and wet color toner is applied to the electrostatic latent image on the photosensitive material 312, to develop the electrostatic latent image (Step S215). After that, the toner on the photosensitive material 312 is transferred to the glass substrate 9 at the transfer position (Step S216). When the whole of toner image on the photosensitive material 312 is completely transferred onto the glass substrate 9, the rotation of the photosensitive drum 31 and the movement of the glass substrate 9 are stopped, and this puts an end to the process for forming an image on the glass substrate 9 (Steps S217a and S217b).

In the image forming apparatus 1c, like in the image forming apparatus 1b, adjacent two out of the linear electrodes 222 are connected to each other with the resistance element 224 (see FIG. 14) and potentials are applied thereto from the transfer potential power supply 227 and the auxiliary potential power supplies 228 through the transfer potential roller 225 and the auxiliary potential rollers 226, and the distribution of potential shown in the upper side of FIG. 14 is thereby formed on the upper surface of the insulating member 221. With this, like in the first and third preferred embodiments, the potential having the distribution where the difference between the potential and the surface potential of the photosensitive material 312 gradually decreases as the distance from the transfer position toward the traveling direction of the substrate holding part 21 and its opposite direction becomes larger is given to the lower surface of the glass substrate 9 opposite to the upper surface through the holding surface 210. As a result, the potential having a similar distribution is given to the upper surface, to prevent the discharge from occurring in the gap between the photosensitive material 312 and the glass substrate 9 in the vicinity of the transfer position, and it is thereby possible to transfer an image to the substrate with high accuracy.

In the image forming apparatus 1c, since the resistance material 223 is omitted, the construction of the apparatus can be simplified. If an object to which an image is transferred is the glass substrate 9, since the object has a sufficient thickness, it is possible to smooth the distribution of potential on the upper surface of the glass substrate 9 even without the resistance material 223.

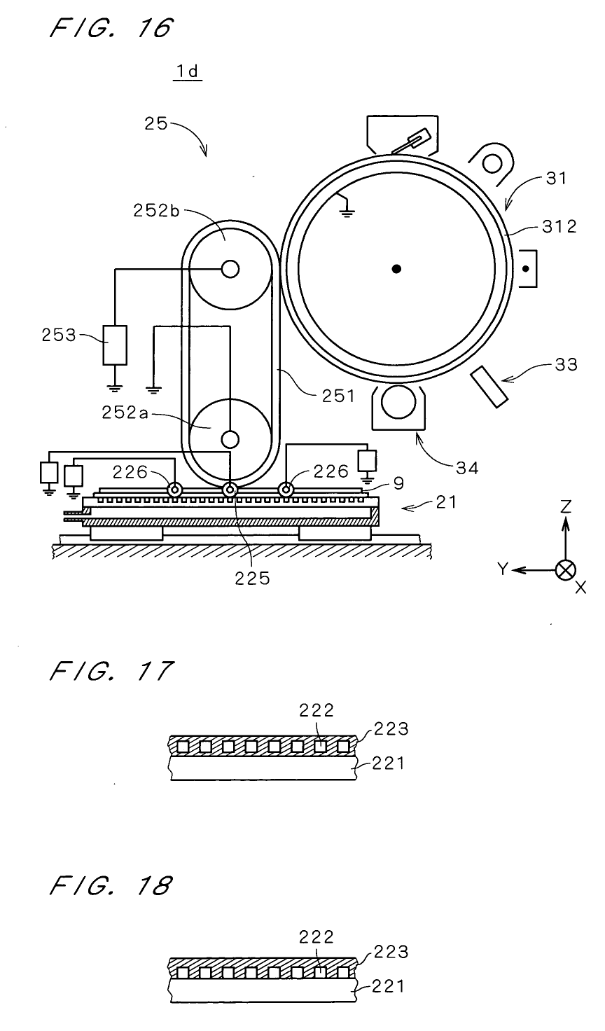

FIG. 16 is a view showing a constitution of an image forming apparatus 1d in accordance with the fifth preferred embodiment. In the image forming apparatus 1d of FIG. 16, the intermediate transfer part 25 having the intermediate transfer member 251 is provided and the toner image on the photosensitive drum 31 is transferred onto the glass substrate 9 indirectly through the intermediate transfer member 251. Specifically, the intermediate transfer member 251 is a loop member like a flat belt which is formed of a dielectric material, and so provided as to be externally in contact with the two rollers 252a and 252b. A motor is connected to one roller 252a, and with the motor driven, the intermediate transfer member 251 comes into contact with a portion of the photosensitive drum 31 where the toner image is formed while rotatingly moving along the outer peripheral surface. The DC power supply 253 is connected to the other roller 252b.

In the image forming apparatus Id of FIG. 16, the toner image formed on the photosensitive material 312 by the latent image forming part 33, the developing part 34 and the like is transferred onto the intermediate transfer member 251 which is rotatingly moved by a potential applied through the roller 252b. The portion of the intermediate transfer member 251 on which the toner image is formed is moved to the glass substrate 9 and the toner image on the intermediate transfer member 251 is thereby transferred onto the glass substrate 9. At this time, the potential having the same distribution as that in the third preferred embodiment is given to the upper surface of the glass substrate 9 by the transfer potential roller 225 and the auxiliary potential rollers 226, and it is thereby possible to transfer the toner image while preventing the discharge in the vicinity of the transfer position.

In the image forming apparatus 1d of FIG. 16, the glass substrate 9 is moved in the (−Y) direction of FIG. 16 in image formation. Further, in the image forming apparatuses 1b to 1d, there may be another case where the developing part 34 is omitted and the transfer potential having a polarity reverse to that of the electric charges of the electrostatic latent image is applied to the glass substrate 9 by the transfer potential roller 225 and the electrostatic latent image on the photosensitive material 312 or the electrostatic latent image transferred onto the intermediate transfer member 251 from the photosensitive material 312 is transferred onto the glass substrate 9.

Thus, in the image forming apparatuses 1b to 1d, the photosensitive drum 31 or the intermediate transfer part 25 operates as the original image holding part which rotatingly moves the loop member like a cylindrical drum or a flat belt along its outer peripheral surface on which an original image which is the toner image or the electrostatic latent image to be transferred to the glass substrate 9 is formed and the original image which is an object to be transferred to the glass substrate 9 is thereby moved to the transfer position and transferred onto the glass substrate 9. There may be another case where a multistylus which is a set of pin electrodes is provided as the latent image forming part and a loop member formed of a dielectric material is provided in the original image holding part and a voltage is applied to the pin electrodes which face the outer peripheral surface of the loop member with a gap interposed therebetween to cause discharge between the tips of the pin electrodes and the loop member, and the electric charges are thereby applied to the outer peripheral surface of the loop member to form an electrostatic latent image.

Though the image forming apparatuses 1b to 1d of the third to fifth preferred embodiments have been discussed above, the image forming apparatuses 1b to 1d allow various variations other than the above examples.

Though the auxiliary potential rollers 226 are provided on both sides of the transfer position in the Y direction parallel to the traveling direction of the glass substrate 9 in image formation in the third to fifth preferred embodiments, the auxiliary potential roller 226 may be provided only on the (+Y) or (−Y) side of the transfer position. From the viewpoint that the toner image should be transferred from the photosensitive material 312 onto the glass substrate 9 with high accuracy, however, it is preferable that not only the auxiliary potential roller 226 on one side of the transfer position but also another like auxiliary potential roller 226 on the other side should be provided and the discharge occurring in the gap between the photosensitive material 312 and the glass substrate 9 should be prevented from both the (+Y) and (−Y) sides of the transfer position like in the third to fifth preferred embodiments.

A plurality of linear electrodes 222 in the image forming apparatus 1b do not have to be exposed from the insulating member 221 but may be buried in the resistance material 223 as shown in FIG. 17, or may be buried on the lower surface side of the resistance material 223 as shown in FIG. 18. In any case, part of each linear electrode 222 in the longitudinal direction is exposed from the resistance material 223 and the exposed portions come into contact with the transfer potential roller 225 and the auxiliary potential rollers 226, to apply a distribution potential to the upper surface of the glass substrate 9.

The through holes 221a to adsorb the glass substrate 9 to the holding surface 210 do not have to be formed only in the insulating member 221 interposed among a plurality of linear electrodes 222, and if the diameter of the through hole 221a is sufficiently smaller than the width of the linear electrode 222, the through hole 221a may be formed in the linear electrode 222. The glass substrate 9 may be mechanically held on the holding surface 210.

Though the number of rollers which come into contact with the linear electrodes 222 is three in the three to fifth preferred embodiments, four or more rollers may be provided on the linear electrodes 222 in order to obtain a stabler distribution of potentials.

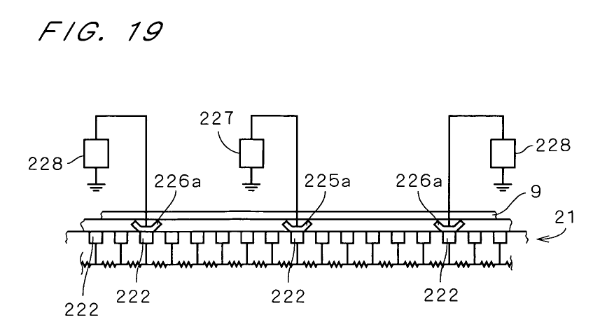

The potential applying mechanism 22 does not necessarily have to be one having rollers (the transfer potential roller 225 and the auxiliary potential rollers 226) but may be a conductive brush, and as shown in FIG. 19, metal or conductive contact segments 225a and 226a which are connected to the transfer potential power supply 227 and auxiliary potential power supplies 228 may come into contact with a plurality of linear electrodes 222 with the movement of the substrate holding part 21, to apply the transfer potential and the auxiliary potential to the linear electrodes 222. Switching of the linear electrodes 222 to which the potentials are applied may be performed electrically.

The photosensitive drum 31 may not come into contact with the glass substrate 9 at the transfer position but there may be another case, for example, where the photosensitive drum 31 approximates to the glass substrate 9 with a very small gap therebetween at the transfer position and the gap is filled with the liquid for transfer. If there is no probability of discharge, only a predetermined potential may be applied to the holding surface 210 in the substrate holding part 21 at least at the transfer position.

The image forming apparatuses 1b to 1d may be used for some purposes other than manufacture of color filters, and an object to be processed in the image forming apparatuses 1b to 1d may be a semiconductor substrate, a printed circuit board or the like, other than the glass substrate 9. In the image forming apparatuses 1b to 1d, since the discharge in the vicinity of the transfer position is prevented, even if a substrate having low capacitance, which is formed of a thick material or a material whose relative dielectric constant is low, is an object, it is possible to transfer and form a toner image or an electrostatic latent image on the substrate with high accuracy by applying a high transfer potential. Thus, substrates of various materials can be processed.

While the invention has been shown and described in detail, the foregoing description is in all aspects illustrative and not restrictive. It is therefore understood that numerous modifications and variations can be devised without departing from the scope of the invention.

This application claims priority benefit under 35 U.S.C. Section 119 of Japanese Patent Application No. 2005-184806 and Japanese Patent Application No. 2005-184807 filed in the Japan Patent Office on Jun. 24, 2005, the entire disclosure of which is incorporated herein by reference.

What is claimed is:

1. An image forming apparatus for forming a toner image or an electrostatic latent image on a substrate, comprising:
an original image holding part for rotatingly moving a loop member like a cylindrical drum or a flat belt along its outer peripheral surface on which an original image which is a toner image or an electrostatic latent image to be transferred is formed;
a moving mechanism for bringing one main surface of said substrate closest to said outer peripheral surface at a predetermined transfer position while moving said substrate at the same speed as a portion of said loop member goes at said transfer position in a traveling direction along said one main surface which is the same direction as said portion of said loop member; and
a transfer part for transferring said original image on said outer peripheral surface to said substrate at said transfer position while applying a potential to a surface of said substrate opposite to said one main surface, said potential having a distribution where difference between said potential and a surface potential of said loop member gradually decreases as the distance from said transfer position toward said traveling direction or one direction opposite to said traveling direction becomes larger.

2. The image forming apparatus according to claim 1, further comprising
a supporting member having a contact surface which comes into contact with said surface of said substrate opposite to said one main surface in the vicinity of said transfer position,
wherein said transfer part generates a potential having said distribution at said contact surface of said supporting member.

3. The image forming apparatus according to claim 2, wherein
said supporting member is formed of a semiconductor material having a constant thickness, and
said transfer part comprises
a first potential applying part for applying a first potential to a position on a surface of said supporting member opposite to said contact surface, said position being closest to said transfer position, and
a second potential applying part for applying a second potential which is nearer to said surface potential of said loop member than said first potential to said supporting member at a position away from said first potential applying part at a predetermined distance toward said one direction, to generate a potential having said distribution on said supporting member.

4. The image forming apparatus according to claim 3, wherein
said second potential has a polarity opposite to that of said first potential, or is a ground potential.

5. The image forming apparatus according to claim 3, wherein
at least one of said first potential applying part and said second potential applying part comprises a roller which comes into contact with said surface of said supporting member opposite to said contact surface, and said roller is formed by covering the surrounding of an electrode to which said first potential or said second potential is applied, with a conductive elastic material.

6. The image forming apparatus according to claim 3, wherein
said first potential applying part is a corona discharger.

7. The image forming apparatus according to claim 3, wherein
said second potential applying part comprises a brush which is formed of a conductive material and comes into contact with said surface of said supporting member opposite to said contact surface.

8. The image forming apparatus according to claim 1, wherein
a distribution of said potential which is applied by said transfer part to said surface of said substrate opposite to said one main surface further has a distribution where difference between said potential and said surface potential of said loop member gradually decreases as the distance from said transfer position toward a direction opposite to said one direction becomes larger.

9. The image forming apparatus according to claim 8, further comprising
a supporting member having a contact surface which comes into contact with a surface of said substrate opposite to said one main surface in the vicinity of said transfer position,
wherein said transfer part generates a potential having said distribution at said contact surface of said supporting member.

10. The image forming apparatus according to claim 9, wherein
said supporting member is formed of a semiconductor material having a constant thickness, and
said transfer part comprises
a first potential applying part for applying a first potential to a position on a surface of said supporting member opposite to said contact surface, said position being closest to said transfer position, and
two second potential applying parts for applying a second potential which is nearer to said surface potential of said loop member than said first potential to said supporting member at positions away from said first potential applying part at a predetermined distance toward said one direction and a direction opposite to said one direction, respectively, to generate a potential having said distribution on said supporting member.

11. The image forming apparatus according to claim 10, wherein
said second potential has a polarity opposite to that of said first potential, or is a ground potential.

12. The image forming apparatus according to claim 10, wherein
at least one of said first potential applying part and said two second potential applying parts comprises a roller which comes into contact with said surface of said supporting member opposite to said contact surface, and said roller is formed by covering the surrounding of an electrode to which said first potential or said second potential is applied, with a conductive elastic material.

13. The image forming apparatus according to claim 10, wherein
said first potential applying part is a corona discharger.

14. The image forming apparatus according to claim 10, wherein
said two second potential applying parts each comprise a brush which is formed of a conductive material and comes into contact with said surface of said supporting member opposite to said contact surface.

15. The image forming apparatus according to claim 1, further comprising
a substrate holding part for holding said substrate on a flat holding surface formed on a member having rigidity,
wherein said moving mechanism moves said substrate holding part to move said substrate, and
said transfer part is a potential applying mechanism for applying said potential to said holding surface.

16. The image forming apparatus according to claim 15, wherein
said potential applying mechanism comprises
a plurality of linear electrodes each extending in a direction orthogonal to said traveling direction, which are arranged in said traveling direction at a regular pitch in said substrate holding part,
a resistance material covering said plurality of linear electrodes and having a surface which serves as said holding surface, and
a potential applying electrode shift mechanism for applying a first potential to one of said plurality of linear electrodes which is located at said transfer position, applying a second potential which is nearer to a surface potential of said loop member than said first potential to one of said plurality of linear electrodes which is located away from said transfer position at a predetermined distance in said traveling direction or a direction opposite to said traveling direction, and sequentially shifting a linear electrode to which said first potential is applied and a linear electrode to which said second potential is applied in synchronization with movement of said substrate holding part.

17. The image forming apparatus according to claim 16, wherein
adjacent two of said plurality of linear electrodes are connected to each other with a resistance element having a resistance value lower than that of said resistance material located between adjacent two linear electrodes.

18. The image forming apparatus according to claim 16, wherein
said potential applying mechanism comprises a roller which comes into contact with one of said plurality of linear electrodes to which said first potential or said second potential is applied, and said roller is formed by covering the surrounding of a center electrode to which said first potential or said second potential is applied, with a conductive elastic material.

19. The image forming apparatus according to claim 16, wherein
said second potential has a polarity opposite to that of said first potential, or is a ground potential.

20. The image forming apparatus according to claim 15, wherein
said potential applying mechanism comprises
a plurality of linear electrodes exposed from said holding surface and arranged in said traveling direction at a regular pitch, each extending in a direction orthogonal to said traveling direction,
an insulator interposed among said plurality of linear electrodes to form said holding surface together with said plurality of linear electrodes,
a plurality of resistance elements each for connecting adjacent two of said plurality of linear electrodes, and
a potential applying electrode shift mechanism for applying a first potential to one of said plurality of linear electrodes which is located at said transfer position, applying a second potential which is nearer to a surface potential of said loop member than said first potential to one of said plurality of linear electrodes which is located away from said transfer position at a predetermined distance in said traveling direction or a direction opposite to said traveling direction, and sequentially shifting a linear electrode to which said first potential is applied and a linear electrode to which said second potential is applied in synchronization with movement of said substrate holding part.

21. The image forming apparatus according to claim 20, wherein
said potential applying mechanism comprises a roller which comes into contact with one of said plurality of linear electrodes to which said first potential or said second potential is applied, and said roller is formed by covering the surrounding of a center electrode to which said first potential or said second potential is applied, with a conductive elastic material.

22. The image forming apparatus according to claim 20, wherein
said second potential has a polarity opposite to that of said first potential, or is a ground potential.

23. The image forming apparatus according to claim 15, wherein
said potential applying mechanism comprises
a plurality of linear electrodes each extending in a direction orthogonal to said traveling direction, which are arranged in said traveling direction at a regular pitch in said substrate holding part,
a resistance material covering said plurality of linear electrodes and having a surface which serves as said holding surface, and
a potential applying electrode shift mechanism for applying a first potential to one of said plurality of linear electrodes which is located at said transfer position, applying a second potential which is nearer to a surface potential of said loop member than said first potential to ones of said plurality of linear electrodes which are located away from said transfer position at a predetermined distance toward said traveling direction and a direction opposite to said traveling direction, and sequentially shifting a linear electrode to which said first potential is applied and linear electrodes to which said second potential is applied in synchronization with movement of said substrate holding part.

24. The image forming apparatus according to claim 23, wherein
adjacent two of said plurality of linear electrodes are connected to each other with a resistance element having a resistance value lower than that of said resistance material located between adjacent two linear electrodes.

25. The image forming apparatus according to claim 23, wherein
said second potential has a polarity opposite to that of said first potential, or is a ground potential.

26. The image forming apparatus according to claim 15, wherein
said potential applying mechanism comprises
a plurality of linear electrodes exposed from said holding surface and arranged in said traveling direction at a regular pitch, each extending in a direction orthogonal to said traveling direction,
an insulator interposed among said plurality of linear electrodes to form said holding surface together with said plurality of linear electrodes,
a plurality of resistance elements each for connecting adjacent two of said plurality of linear electrodes, and
a potential applying electrode shift mechanism for applying a first potential to one of said plurality of linear electrodes which is located at said transfer position, applying a second potential which is nearer to a surface potential of said loop member than said first potential to ones of said plurality of linear electrodes which are located away from said transfer position at a predetermined distance toward said traveling direction and a direction opposite to said traveling direction, and sequentially shifting a linear electrode to which said first potential is applied and linear electrodes to which said second potential is applied in synchronization with movement of said substrate holding part.

27. The image forming apparatus according to claim 26, wherein
said second potential has a polarity opposite to that of said first potential, or is a ground potential.

28. The image forming apparatus according to claim 1, wherein
said original image is a toner image formed by applying liquid toner to an electrostatic latent image on said outer peripheral surface.

29. An image forming method for forming a toner image or an electrostatic latent image on a substrate, comprising:
a rotatingly-moving step of rotatingly moving a loop member like a cylindrical drum or a flat belt along its outer peripheral surface on which an original image which is a toner image or an electrostatic latent image to be transferred is formed;
a moving step of bringing one main surface of said substrate closest to said outer peripheral surface at a predetermined transfer position while moving said substrate at the same speed as a portion of said loop member goes at said transfer position in a traveling direction along said one main surface which is the same direction as said portion of said loop member, concurrently with said rotatingly-moving step; and
a transferring step of transferring an original image on said outer peripheral surface to said substrate at said transfer position concurrently with said moving step,
wherein a potential having a distribution where difference between said potential and a surface potential of said loop member gradually decreases as the distance from said transfer position toward said traveling direction or a direction opposite to said traveling direction becomes larger is applied to a surface of said substrate opposite to said one main surface in said transferring step.

30. The image forming method according to claim 29, wherein
said substrate is held on a flat holding surface formed on a member of a substrate holding part, which has rigidity, and said substrate holding part is moved to move said substrate in said moving step, and
a potential applying mechanism in said substrate holding part applies said potential to said holding surface in said transferring step.

31. The image forming method according to claim 30, wherein
said potential applying mechanism comprises
a plurality of linear electrodes each extending in a direction orthogonal to said traveling direction, which are arranged in said traveling direction at a regular pitch in said substrate holding part; and
a resistance material covering said plurality of linear electrodes and having a surface which serves as said holding surface, and
a first potential is applied to one of said plurality of linear electrodes which is located at said transfer position, a second potential which is nearer to a surface potential of said loop member than said first potential is applied to one of said plurality of linear electrodes which is located away from said transfer position at a predetermined distance in said traveling direction or a direction opposite to said traveling direction, and a linear electrode to which said first potential is applied and a linear electrode to which said second potential is applied are sequentially shifted in synchronization with movement of said substrate holding part in said transferring step.

32. The image forming method according to claim 31, wherein
said second potential has a polarity opposite to that of said first potential, or is a ground potential.

33. The image forming method according to claim 30, wherein
said potential applying mechanism comprises
a plurality of linear electrodes exposed from said holding surface and arranged in said traveling direction at a regular pitch, each extending in a direction orthogonal to said traveling direction;
an insulator interposed among said plurality of linear electrodes to form said holding surface together with said plurality of linear electrodes; and
a plurality of resistance elements each for connecting adjacent two of said plurality of linear electrodes, and
a first potential is applied to one of said plurality of linear electrodes which is located at said transfer position, a second potential which is nearer to a surface potential of said loop member than said first potential is applied to one of said plurality of linear electrodes which is located away from said transfer position at a predetermined distance in said traveling direction or a direction opposite to said traveling direction, and a linear electrode to which said first potential is applied and a linear electrode to which said second potential is applied are sequentially shifted in synchronization with movement of said substrate holding part in said transferring step.

34. The image forming method according to claim 33, wherein
said second potential has a polarity opposite to that of said first potential, or is a ground potential.

35. The image forming method according to claim 29, wherein
said original image is a toner image formed by applying liquid toner to an electrostatic latent image on said outer peripheral surface.
